(19) United States
(12) Patent Application Publication
(10) Pub. No.: US 2024/0304031 A1
(43) Pub. Date: Sep. 12, 2024

(54) SYSTEMS AND METHODS FOR ARTIFICIAL-INTELLIGENCE ASSISTANCE IN VIDEO COMMUNICATIONS WITH COMMUNICATION-IMPAIRED USERS

(71) Applicant: LIVEPERSON, INC., New York, NY (US)

(72) Inventor: Amit Mishra, Broomfield, CO (US)

(73) Assignee: LIVEPERSON, INC., New York, NY (US)

(21) Appl. No.: 18/600,941

(22) Filed: Mar. 11, 2024

Related U.S. Application Data
(60) Provisional application No. 63/451,334, filed on Mar. 10, 2023.
(60) Provisional application No. 63/451,330, filed on Mar. 10, 2023.

(51) Int. Cl. G06V 40/20; G06V 10/764; G06V 10/774; G06V 10/82; G06V 20/40; G09B 21/00

(52) U.S. Cl. CPC G06V 40/20; G06V 10/764; G06V 10/774; G06V 10/82; G06V 20/46; G09B 21/00

(57) ABSTRACT

A communication assist service may extract one or more video frames during a communication session between a user device and a terminal device. The video frames may include a representation of a gesture provided by a user of the user device. The communication assist service may generate a feature vector from the video frames and execute a trained neural network configured to generate classify the semantic meaning of gesture. The neural network may output the semantic meaning of the gesture, which may be used to generate an appropriate communication response to the gesture. The communication assist service may facilitate transmission of the communication response to a device of the new communication session in real time.

### CROSS-REFERENCE TO RELATED APPLICATIONS

The present patent application claims the benefit of priority to U.S. Provisional Patent Application No. 63/451,334 filed Mar. 10, 2023 and U.S. Provisional Patent Application No. 63/451,330 filed Mar. 10, 2023, which are incorporated herein by reference in their entirety for all purposes.

### TECHNICAL FIELD

This disclosure generally relates to artificial-intelligence assistance systems; and more specifically to processing video communication by artificial-intelligence assistance systems for improved video communication sessions.

### BACKGROUND

Most communication networks rely on the use of text or voice-based communications for communication sessions between users and agents of the communication networks. For example, a user, operating a telephone, may call a call center to facilitate a voice-based communication session with an agent. For some users, voice-based communications may be sufficient to resolve issue (e.g., the purpose the user established a connection with the communication network, etc.). For other users, voice-based communication may not be sufficient to resolve the issue due to a communication mismatch between the user and the agent. For instance, the user may speak a different language than the agent, the user may not be capable of verbal communications (e.g., unable to speak a formal, language due to a disability, etc.), the user may lack the vocabulary needed to discuss the issue, the user may not understand the agent (e.g., due to a poor connection, an accent, a disability, etc.), etc. A communication network may use an alternative communication channel such as video to increase a likelihood of the user's issue may be resolved. However, communication issues that prevent an understanding between the user and the agent will not be resolved by simply adding video.

### SUMMARY

Methods and systems are described herein for artificial-intelligence assistance in video communications. The methods include: extracting one or more video frames from video streams of a set of historical communication sessions, wherein the video frames include a representation of a gesture; defining a training dataset from the one or more video frames and features extracted from the set of communication sessions; training a neural network using the training dataset, the neural network being configured to classify gesture as communications; extracting a video frame from a new video stream of a new communication session, wherein the video frame includes a representation of a particular gesture; executing the neural network using the video frame, wherein the neural network generates a predicted classification of the particular gesture; generating a communication corresponding to the predicted classification of the gesture; and facilitating a transmission of a communication response, the communication response being a response to the particular gesture.

Systems are described herein for artificial-intelligence assistance in video communications. The systems include one or more processors and a non-transitory computer-readable medium storing instructions that, when executed by the one or more processors, cause the one or more processors to perform any of the methods as previously described.

Non-transitory computer-readable media are described herein for storing instructions that, when executed by the one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example artificial-intelligence communication assistance system for video communications according to aspects of the present disclosure.

FIG. 2A illustrates a block diagram of an artificial-intelligence communication assistance system configured to train and use models to provide assistance to agents during video communications according to aspects of the present disclosure.

FIG. 2B illustrates a block diagram of a communication assistance system configured to provide assistance to agents during video communications according to aspects of the present disclosure.

FIG. 3 depicts a block diagram of an example artificial-intelligence data processing system of an automated service configured to automate communications of a communication network according to aspects of the present disclosure.

FIG. 4 illustrates a block diagram of an example system for aggregating training data configured to train a machine-learning model to provide assistance in video communications according to aspects of the present disclosure.

FIG. 5 illustrates a flowchart of an example process for artificial-intelligence assistance in video communications according to aspects of the present disclosure.

FIG. 6 illustrates an example computing device architecture of a computing device that can implement the various techniques described herein according to aspects of the present disclosure

### DETAILED DESCRIPTION

A communication network (e.g., such as call center, a cloud network, or the like that provides communication services for a domain such as a business, etc.) may be accessed by user devices to establish communications sessions with terminal devices (e.g., operated by agents) of the communication network to resolve an issue associated with the user device (e.g., to receive technical support, request information, update information, provide payment, return a product or service, etc.). In some instances, the user device and/or the user thereof may have trouble communicating over traditional a voice-based communication channels (e.g., such as telephony, etc.). For instance, the user may be speech-impaired, have other disabilities that may prevent speech-based communications. In those instances, the communication network may utilize a video-based communication channel to enable communications. Yet, video-based communication channels may only enable non-voice-based communications when both the user and agent are proficient in a common communication protocol (e.g., such as American sign language (ASL), or the like). If either the user or the agent are not proficient in a common non-voice-based communication protocol, then video-based communications may be no better in enabling communications for speech-impaired users.

Methods and systems are described herein for artificial-intelligence assistance in video communications with speech-impaired users. A communication network may instantiate, train, and execute machine-learning models configured to analyze video-based communication sessions (e.g., over a video-based communication channel) in real time (e.g., during the video-based communication session). The machine-learning models may generate classifications of gestures provided by a particular user represented in the video, generate predictions associated with a semantic meaning of the gestures, generate communication responses to the gestures, and/or the like that can be provided to the agent during the video-based communication session. The agent may use the output from the machine-learning models to communicate with users that lack an ability to communicate using standard voice-based communications (e.g., such users who are speech impaired, users who are non-verbal, users with anxiety or other communication disabling disorders, etc.). The video and/or the output from the machine-learning models may also be used to train other machine-learning models and/or agents to further improve those machine-learning models and/or agents in communicating with users that lack an ability to communicate using standard voice-based communications.

For example, a speech-impaired user, via a user device, may connect to a communication network over a video-based communication channel to communicate with a terminal device operated by an agent of the communication network. In some instances, the speech-impaired user may indicate an issue for which the communication session is to be established (e.g., such as technical support, information request, update information of the communication network, execute and action associated with the communication network such as payment processing, and/or the like). The communication network may connect the user device to a terminal device operated by an agent capable of providing assistance to the user (e.g., based on the issue for which the communication session is established, characteristics of the speech-impaired user and/or user device such as communication capabilities, etc.).

The speech-impaired user may communicate with the agent using gestures, non-verbal speech or sound (e.g., such as single or multi-tone vocal sound, other non-verbal vocal sound, etc.), and/or the like. An artificial-intelligence (AI) communication assist service may analyze the communication session for gestures provided by the speech-impaired user using video frames, sets of video frames, corresponding audio segments, and/or the like. The communication assist service may classify the gestures within the video frame according to a class with a corresponding semantic meaning. Alternatively, the communication assist service may predict a semantic meaning of the gesture. The communication assist service may present the agent with an identification of the gesture within the video frame (e.g., using boundary boxes to indicate the location of gesture, etc.), an indication of the semantic meaning of the gesture, an identification of one or more suggested responses to the gesture, or the like.

The communication assist service may include one or more machine-learning models configured to process aspects of the video session such as but not limited to, the video (e.g., for object/gesture detection, image analysis/processing, classification, etc.), the audio (e.g., to identify meaning behind non-verbal audio segments, etc.), and/or the like. The machine-learning models may generate an output that translates the gestures of the speech-impaired user into form understandable to the agent or parsable by an automated service. In some instances, the machine-learning models may translate the video frames of the video session to generate a translation of the gestures. In other instances, the machine-learning models may use both video frames and corresponding audio segments (e.g., non-verbal sounds, etc.) to generate a translation of the gestures. For instance, some speech-impaired users may be able to generate sounds that can convey meaning. The sounds may correspond to a distinct meaning or may be usable as context to assign meaning to one or more gestures. The communication assist service may some machine-learning models to process video or video frames (e.g., such as a convolutional neural network, etc.). Other machine-learning models, such as a recurrent neural network, may be configured to process sequences of video frames and/or sound segment by retaining data between iterations of the machine-learning models. In some instances, the one or more machine-learning models may be an ensemble model (e.g., a machine-learning model that includes two or more machine-learning models, which when operating together may perform the aforementioned functionality of the one or more machine-learning models) or a neural network comprising a one or more of convolutional layers, recurrent layers, pooling layer, fully connected layers, combinations thereof, or the like.

The one or more machine-learning models may include, but are not limited to neural networks, generative adversarial networks, deep learning networks, transformers (e.g., a generative pre-trained transformer (GPT) model, etc.), recurrent neural networks, convolutional neural networks, classifiers, support vector machines, Naïve Bayes, K-nearest neighbors. K-means, random forest, other clustering-based models, regression-based models, decision trees, and/or the like.

The communication network may receive communications associated with multiple historical communication sessions facilitated by the communication network (e.g., over one or more time intervals), which may be used to define training datasets for the one or more machine-learning models. The training datasets may be augmented with additional information associated with the video frames and/or the video session configured to improve an accuracy of the output of the one or more machine-learning models. Examples of the additional information include, but are not limited to, information associated with a business, products and/or services provided by the business, information associated with a website or webserver of the business, related businesses, an identification of the user device and/or the user thereof, information associated with the user device and/or agent device, information associated with the same or similar issues as the issues provided by the user as the reason for the user establishing the communication session, demographic information associated with the user (e.g., such as, but not limited to, location socioeconomic status, current employment, etc.), an identification of a user profile or account associated with the user, an identification of communication capabilities and/or disabilities of the user, an identification of communication capabilities of the agent, information and/or actions that resolved the same or similar issues, information and/or actions provided or recommended by the terminal device and/or the agent, information and/or actions provided or recommended by the communication assist service and/or an automated service, and/or the like.

In some instances, the communication network may preprocess the training datasets to reduce the quantity of unique data types or the quantity of data of each training dataset. For example, video frames may be processed by, for example, grayscale conversion (e.g., converting an image from color to grayscale), normalization of features or characteristics, data augmentation (e.g., adding features based on an analysis of the video frame, annotations, etc.), video frame standardization, edge detection, etc. Audio segments and/or text may also be preprocessed by standardizing words into a base or common form that is capable of conveying the semantic meaning of multiple versions of a word as a single word. For example, preprocessing may include converting audio segments into alphanumeric strings; parsing alphanumeric strings into word segments (e.g., tokenization); removing word segments that, while grammatically necessary, do not contribute to the meaning the data such as articles (e.g., ‘a’, ‘an’, ‘the’, etc.); removing punctuation; replacing conjugated verbs with their non-conjugated base forms (e.g., “walking”, “walked”, and “walks,” can be replaced with “walk”, etc.). In some instances, the communication network may also classify the data of the training datasets as corresponding to one or more semantic categories. Upon determining that the received data corresponds to a particular semantic category, the received data may be replaced with the semantic category. For example, an input phrase of “our store is open from Monday to Friday” may be classified as the data pair: “store hours” and “Monday to Friday”.

In some examples, the communication network may include one or more additional machine-learning models configured to preprocess the data of the training datasets. The one or more additional machine-learning models may be configured to convert from audio to text (e.g., convert speech into alphanumeric strings, etc.), parse natural-language alphanumeric strings into a non-natural language reduced form that is semantically equivalent, convert natural-language alphanumeric strings into an alternative format (e.g., classification as previously described, etc.), process video frames, generate boundary boxes within video frames, perform object detection/identification within video frames, perform predictions based on video frames and/or corresponding audio segments, generate natural language communications, and/or the like.

Additional features may be added to the training datasets to augment the data of the training datasets and/or to provide context usable by the one or more machine-learning models to assist a terminal device and/or the agent thereof. The additional data may correspond to features extracted from other portions of the training dataset, features associated with a source of the training datasets (e.g., features that correspond to a data source or device, features that identify the data source, etc.), features associated with a user or agent that generated or is associated with the data of the training datasets, an identification of a data type of the data of the training datasets, a timestamp corresponding to when the data of the training datasets was generated and/or received, combinations thereof, or the like. Video frames that include a representation of a gesture may be annotated with an identification of the gesture, a boundary box indicating the location and size of the gesture (e.g., such as over one or more hands, arms, legs, etc.; over the torso; head; face; entire body; etc.), a location of the user, a timestamp corresponding to the gesture (relative to the time interval of the communication session, or was first detected, etc.), combinations, or the like.

The training datasets may be modified based on the machine-learning model that is to be trained and a target output for the machine-learning model that is to be trained. Each machine-learning model of the one or more machine-learning models may be trained to generate a particular target output. In addition, machine-learning models configured to generate a same target output may be trained for individual users. For example, since speech-impaired users may have different communication capabilities, each speech-impaired user may communicate differently from other speech impaired users (e.g., use different gestures, user different non-verbal sounds, assign different meaning to gestures, etc.). As a result, the communication network may select one or more training datasets for each machine-learning model based on the particular speech-impaired user for which the machine-learning model will be translating (if there is sufficient training datasets that correspond to the particular speech-impaired user), similar speech-impaired users (e.g., users having similar communication capabilities, communication disabilities, who use similar gestures, who assign similar meaning to the same gestures, etc.) if there is insufficient training datasets that correspond to the particular speech-impaired user, the target output for that machine-learning model, the quantity of training datasets usable to train the machine-learning model, etc. The communication network may then modify the training datasets to optimally train a particular machine-learning to generate a particular target output by using a feature selection algorithm (e.g., to include or exclude features useable to train a particular model type, etc.), add features that may improve model training for a particular speech-impaired user or for a particular model type (e.g., using manually or procedurally generated features, etc.), combinations thereof, or the like. For example, a training dataset for a first machine-learning model configured to identify objects within a video frame (e.g., such as, but not limited to a convolutional neural network, or the like) may include video-based features, while a second machine-learning model configured to convert speech-to-text (e.g., such as, but not limited to, a recurrent neural network, etc.) may be modified to exclude video-based features, etc.

The communication network may select one or more training datasets for each machine-learning model of the one or more machine-learning models. The communication network may then train the machine-learning models to generate a target output. The one or more machine-learning models may be trained for a predetermined time interval, for a predetermined quantity of iterations, based on a target accuracy of the machine-learning model, combinations thereof, or the like. For example, the training time interval may begin when training begins and end when a target accuracy threshold is reached (e.g., accuracy, precision, area under the curve, logarithmic loss, F1 score, mean absolute error, mean square error, etc.). The machine-learning models may be trained using supervised learning, unsupervised learning, semi-supervised learning, reinforcement learning, combinations thereof, or the like. The type of training to be used may be selected based on the type of machine-learning model being trained. For instance, a regression model may use supervised learning (or a variation thereof), while a clustering model may use unsupervised learning (or a variation thereof), etc. Alternatively, the type of learning may be selected based on the target output and/or a type or quality of the training data available to train the machine-learning models.

Once the one or more machine-learning models are trained, the communication network may define processes and/or interfaces configured to connect the one or more machine-learning models to enable a single input to generate a particular output. For example, a terminal device of a video session may receive one or more video frames including a representation of a gesture. The processes and/or interfaces enable the output of a first machine-learning model configured to identify and classify the gesture, to be passed as input to a second machine-learning model configured to generate a natural language response based on the classification assigned to the gesture from the first machine-learning model. The output from the second machine-learning model may be passed as input to a third machine-learning model configured to translate the natural language response into a form or format parsable by the speech-impaired user (e.g., into synthetic voice-based audio segments for speech-impaired users that can hear, into a representation of a gesture, into another language, into text, etc.). The processes and/or interfaces may be configured to translate the output of one machine-learning model into a new form or format for the next machine-learning model in the processing sequence. Alternatively, or additionally, the processes and/or interfaces may further process the output of machine-learning models, verify the accuracy of the output of machine-learning models (e.g., using characteristics of the video session, audio segments, etc.), normalize the output of machine-learning models, combinations thereof, or the like.

The communication network may define multiple processes and/or interfaces to enable the one or more machine-learning models to process different forms of communication (e.g., video-based communication which can include voice and/or gesture-based communications, voice-based communication, data, text, etc.) received over different communication channels (e.g., videoconference, telephone, text messaging, email, data, etc.). As a result, the communication network may structure the one or more machine-learning models and the processes and/or interfaces in various configurations and sequences based on the communication channel and types of communications transmitted over the communication channel.

In an illustrative example, a computing device may extract one or more video frames from video streams of a set of historical communication sessions. The video frames may include a representation of a gesture made by a user communicating over the communication session with an agent operating a terminal device. For example, the user may have a communication-based disability that prevents or limits the user's ability to communicate using verbal-based communications (e.g., such as a hearing-impairment, speech-impairment, muscle-impairment, etc.).

In some instances, the computing device may also extract features from the video data associated with each category. The features may correspond to information associated with the video data or a particular video session represented in the video data. For example, the features may include characteristics of a video session; an identification of the users, agents, automated services, user devices, terminal devices, etc. involved in the video session; an identification of an outcome of the video session; an identification of the time in which the video session began; the duration of the video session; an identification of a location of the user device or the user thereof; a label to be associated with the video session during a training phase; combinations thereof; or the like.

The computing device may define a training dataset from the one or more video frames and features extracted from the set of communication sessions. The training dataset may include data from a set of communication sessions including, but not limited to, one or more video frames from each video session, features derived from the one or more video frames and/or the communication session, and/or the like. The training dataset may be derived from communication sessions involving a single user. Since each user may communicate using different gestures from other users, defining a training dataset derived from communication sessions involving a same user may result in a training dataset capable of training a neural network to generate the most accurate gesture translations for that user. The computing device may assign identifiers to the training dataset (and/or to the data derived from a communication session). An identifier corresponds to a characteristic of a communication session that enables. The computing device may use the identifiers to identify a training dataset (and/or data associated with a communication session) that may be similar to or the same as a reference communication session associated with a particular user.

The one or more identifiers may be generated by a machine-learning model (e.g., such as a clustering-based model) configured to detect patterns and/or common features from the historical communication sessions. Examples of identifiers that may be included in the one or more identifiers may include, but are not limited to, an identification of the user (e.g., a user identifier, a user profile, etc.), an identification of the user device operated by the user (e.g., such as a telephone number, Internet Protocol (IP) address, media access control address, mobile advertising ID (MAID), hardware and/or software installed within the user device, communication software and/or protocols used or usable by the user device, etc.), communication capabilities and/or disabilities of the user, communication capabilities of the terminal device and/or the agent thereof, one or more issues for which the communication session was established, an indication of the resolution of the communication session (e.g., where the issues of the user addressed, etc.), a time interval of the communication session, an indication as to whether the terminal device and/or the agent were able to communicate with the user, an identification of third-parties (if any) associated with the communication sessions (e.g., social workers and/or other individuals that improved communications transmitted from the user device), an identification of one or more gestures provided by the user and/or the agent, an indication of whether non-verbal sounds improved or worsened communications between the user and the agent, an identification of the non-verbal sounds provided by the user with a corresponding assigned meaning (if available), and/or the like.

The computing device may assign one or more weights to each identifier according to a multi-purpose hierarchical framework. The multi-purpose hierarchical framework may generate weights for identifiers based on a particular use of the identifier. For instance, a first weight may be generated for identifiers when identifying data of a communication session that may be used for a particular user. In that instance, identifiers associated with an identity of the particular user may be weighted higher than other identifiers (e.g., so as to enable defining datasets from communication sessions to which the particular user was a party). The multi-purpose hierarchical framework may assign other weights to the same identifiers when identifying data of a communication session that may be associated with a particular gesture or sound. The weights may be generated by the machine-learning model, the neural network, user and/or agent input, preset inputs, combinations thereof, and/or the like.

The identifiers and the weights assigned to identifiers may be used to tailor training of a neural network to a particular user and/or group of users. In some instances, the neural network may be trained using datasets associated with a particular user to enable generating a trained neural network configured to translate gestures and/or sounds more accurately for the particular user. In those instances, the weighted identifiers may first identify training datasets (and/or data associated with communication session) that correspond to the particular user. In other instances, the quantity of quality of training datasets associated with the particular user may be insufficient to train the neural network to a threshold accuracy. In those instances, the weighted identifiers may be used to identify additional training datasets that may be a closest fit (e.g., based on which weighted identifiers match the identifiers of the particular user, a quantity of matching identifiers, and/or the like) to the particular user. The computing device may use the training datasets associated with the similar users to train the neural network. Alternatively, the computing device may add some or all of the training datasets associated with the similar users to the training datasets associated with the particular user.

The computing device may train the neural network using the training dataset. The neural network may be configured to classify gestures of a user as communications. For example, the neural network may be configured to output a predicted classification that corresponds to an identification of the gesture, a natural language translation of the gesture, one or more potential responses to the gesture, combinations thereof, or the like. In some instances, the neural network may be a convolutional neural network or another neural network. In other instances, the neural network may be an ensemble neural network including two or more neural networks and/or machine-learning models configured to perform gesture detection and identification from video frames, translate gestures into natural language communications, generate natural language responses, etc. The ensemble neural network may include any of the aforementioned machine-learning models.

The neural network may be trained for a predetermined time interval, for a predetermined quantity of iterations, until one or more accuracy thresholds are satisfied (e.g., such as, but not limited to, accuracy, precision, area under the curve, logarithmic loss, F1 score, mean absolute error, mean square error, combinations thereof, or the like), based on user input, combinations thereof, or the like. Once trained, the neural network may be useable to process video frames of new video sessions in real time (e.g., identifying objects, generating boundary boxes, translating gestures into natural language communications, generating communication responses, etc.).

The computing device may then extract a video frame from a new video stream of a new communication session. The new communication session may be a video-based communication session including a user device operated by a user who may be speech-impaired and an agent device. The video frame may include a representation of a particular gesture intended to convey meaning by the user.

The computing device may determine a frequency with which to extract video frames from the video stream. For example, the computing device may extract each video frame from the video stream (e.g., for 30 frames per second, etc.) when processing resources of the computing devices are available. If the processing load of the computing device increases beyond a threshold, the computing device may switch to a lower extraction rate such as every other video frame (e.g., for 15 frames per second, etc.), every nth video frame, etc. The more video frames extracted per unit time, increases the quantity and accuracy of predictions generated by the neural network. The more video frames extracted per unit time may also reduce the time interval between when data of the neural network is provided to the agent.

The computing device may execute the neural network using the video frame. The neural network may generate a predicted classification of the particular gesture. The neural network may classify gestures according to one or more classifications with each classification corresponding to a meaning. The neural network may predict the classification of the gesture and then assign the meaning corresponding to the predicted classification to the gesture. In some instances, the neural network may generate the predicted output based on the particular gesture and one or more previous communications transmitted over the new communication session (e.g., from the user device and/or from the agent device). For example, during a conversation a current statement may be based on one or more previous statements made during the conversation. The neural network may process the current video frame based on the previous communications transmitted over the new communication channel to define a context that may improve the accuracy of the The computing device may generate a communication response based on the response to the predicted classification of the gesture. In some instances, the communication response may be generated by the neural network. In other instances, the communication response may be generated by another machine-learning model such as, but not limited to, a generative adversarial network, deep learning network, a recurrent or convolutional neural network, etc. The communication response may be a natural language communication based on the predicted classification of the gesture. For example, the predicted classification of the gesture may correspond to a request for information associated with a previous communication (e.g., in which the gesture was a shrug, hand gesture with the palm(s) facing upwards, movement of the head, wrinkling of the skin above eyes, or the like). The communication response may include a natural language response including the additional information associated with the previous communication. Alternatively, the communication may be a sequence of one or more gestures that approximately corresponds to a meaning (to the user) of the natural language response. The sequence of one or more gestures may use the same gestures as used to by the user so as to use gestures having a meaning that is known to the user.

The computing device may facilitate a transmission of the communication response to a device associated with the new communication session. In some instances, the computing device may be configured to operate in an automated setting in which the computing device may automatically generate and transmit the communication response to the user device in response to detecting the gesture. In other instances, the computing device may be configured to operate in an assist setting in which the computing device may automatically generate one or more communication responses in response to detecting the gesture. The one or more communication responses may be transmitted to the terminal device for presentation to the agent thereof. The agent may determine which of the one or more communication responses to transmit to the user device. The agent may communicate the selected one or more communication responses to the user via natural language communications (e.g., voice-based and/or text based). Alternatively, the agent may communicate the selected one or more communication responses to the user via a sequence of one or more gestures that approximately correspond to the meaning (to the user) of the selected one or more natural language communications.

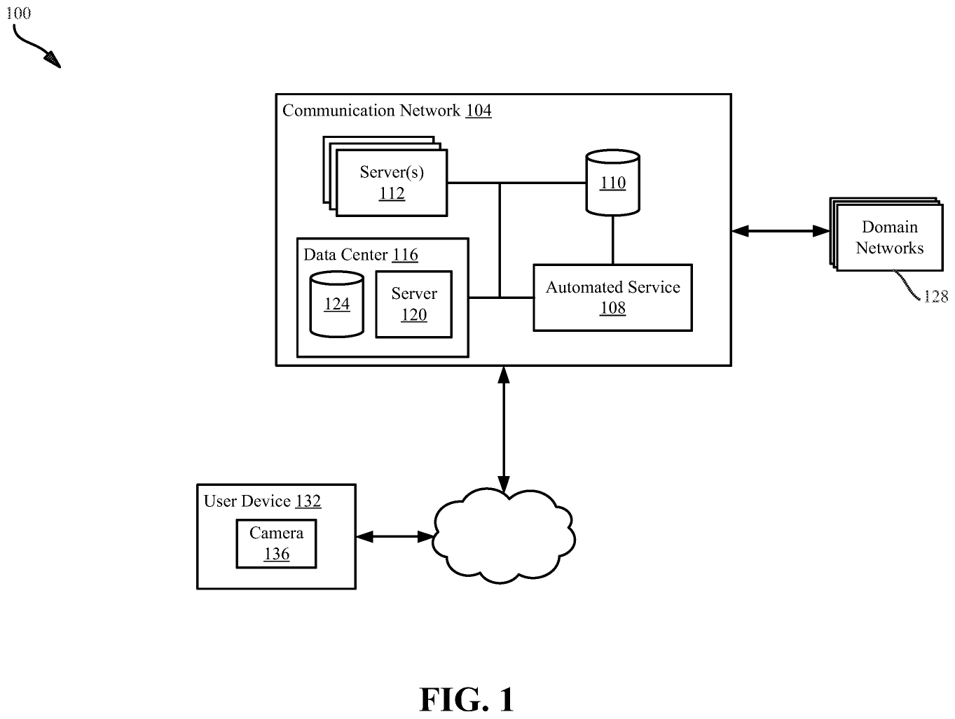

FIG. 1 illustrates a block diagram of an example artificial-intelligence communication assistance system for video communications according to aspects of the present disclosure. Artificial-intelligence communication assistance system 100 (e.g., also referred to as AI communication assist system 100) may include communication network 104 configured to facilitate communications between a terminal device and a user device (e.g., such as user devices 132, etc.) to provide services of one or more domain networks 128 to the user device 132. AI communication assist system 100 may include communication assist and/or automated services configured to enable and improve communications with users that may be communication-impaired (e.g., such as speech-impaired, hearing impaired, seeing-impaired, etc.). User device 132 may connect to communication network 104 to address an issue (e.g., a purpose for which user device established a connection with communication network 104). Communication network 104 may connect user device 132 to a terminal device operating within communication network 104 or to a terminal device allocated to communication network 104 (e.g., a terminal device operating external to communication network 104) that is capable of communicating with the user (e.g., based on the particular communication-impaired of the user).

Alternatively, communication network 104 may connect user device 132 to an automated service (e.g., automated service 108 operating within communication network 104, etc.). Automated services may be configured to provide communication services using natural language communications via text, synthetic speech, gestures (e.g., via an animated avatar, or the like), etc. Automated service 108 may be configured to execute queries, analyze video, provide information, assist agents communicating with user devices by providing suggested communications and/or responses, execute functions of communication network 104 (e.g., for terminal devices, user devices, etc.), translate gestures into natural language communications, generate natural language communications, combinations thereof, or the like. Automated services may obtain information associated with products, services, known technical support issues or solutions, etc. corresponding to domain networks 148 from database 124 of datacenter 116 or directly from domain networks 128.

Communication network 104 may include one or more servers 112, data center 116 (e.g., which may include server 120 and database 124), and one or more terminal devices operated by agents. When user devices connect to communication network 104 (e.g., through network 128 such as the Internet, a telecommunications network, a cloud network, a private network, etc.), communication network 104 may obtain information associated with a reason in which the user device connected to communication network 104 such as, but not limited to, a particular issue detected by the user device or user thereof, an identification of a device or services associated with the particular issue, an identification of the user device and/or the user thereof, a timestamp corresponding to when the particular issue was first detected, a timestamp corresponding to when the particular issue last occurred, a time interval over which the particular issue has occurred, a potential cause of the particular issue, information associated with the detection of the particular issue (e.g., surrounding events, context, metadata, etc.), a location associated with the particular issue, a user profile or account or associated with the user device and/or the user thereof (e.g., usable to identify previous requests for technical support, etc.), communication capabilities of the user, combinations thereof, or the like. Communication network 104 may use the information associated with the reason in which the user device connected to communication network 104 to identify a particular terminal device or automated service that may be configured to assist the user device and/or the user thereof to resolve the particular issue.

Communication network 104 may facilitate a connection between the user device and the selected terminal device or automated service. In some instances, the selected terminal device or automated service may request to modify the communication channel by adding a video layer or switching the communication channel to a video-based communication channel. User device 132 may transmit a video stream or video frames (e.g., discrete images) using camera 136 to the terminal device or automated service. The video-based communication channel may be one-way (e.g., the user device transmits video or video frames) or two-way (e.g., both the user device and the terminal device transmit video or video frames). The terminal device and/or automated service 108 may direct the user to capture video or video frames of the particular issue and/or anything associated with the particular issue to assist in resolving the particular issue.

In some instances, automated service 108 may include an AI communication assist, which may analyze the video and/or audio being transmitted through communication network 104 to the terminal device to assist the terminal device and/or agent in resolving the particular issue. AI communication assist may include one or more machine-learning models configured to process the audio or video and generate information for the agent. The one or more machine-learning models may be configured to detect a gesture intended to convey a meaning, identify the detected gesture, determine a meaning associated with the gesture, generate natural language representations of the meaning associated with the gesture based on a communication channel being used (e.g., voice-based communication, text-based communications, etc.), generate a response to the gesture based on the meaning associated with the gesture, translate the response based on the communication channel and/or the communication capabilities of the user, combinations thereof, or the like.

For example, user device 132 may be operated by a communication-impaired user and connected to communication network 104 to address an issue associated with the communication network and/or a domain for which the communication network provides services. Communication network 104 may connect user device 132 to a particular terminal device that may be capable of communicating with the user based on the communication capabilities of the user. During the video session, the AI communication assist may generate information for the terminal device such as, for example, boundary boxes around identified gestures, identify and translate gestures provided by the user (e.g., such as, but not limited to, static gesture represented by a single video frame or a motion gesture represented by sequence of video frames, etc.), generate a natural language representation of the gesture represented via text or a synthetic voice, generate a natural language or gesture response, combinations thereof, or the like. The AI communication assist may generate a presentation for the agent device and/or the user device corresponding to the generated information. The presentation may include the raw information (e.g., such as the information as its generated by the AI communication assist) or a formalized representation of the information (e.g., a natural language representation that appears as if generated by the agent or another human). In some instances, the presentation may include one or more suggested communications involving the generated information that can be transmitted by the agent (e.g., via voice-based communications, gesture-based communications, text-based communications, etc.). The AI communication assist generate the presentation in real time (e.g., approximately immediately after AI communication assist processes a video frame) so as to provide real time assistance to the agent device.

The agent device may use the generated information to communicate with communication-impaired users, improve communications with communication-impaired users, and/or the like.

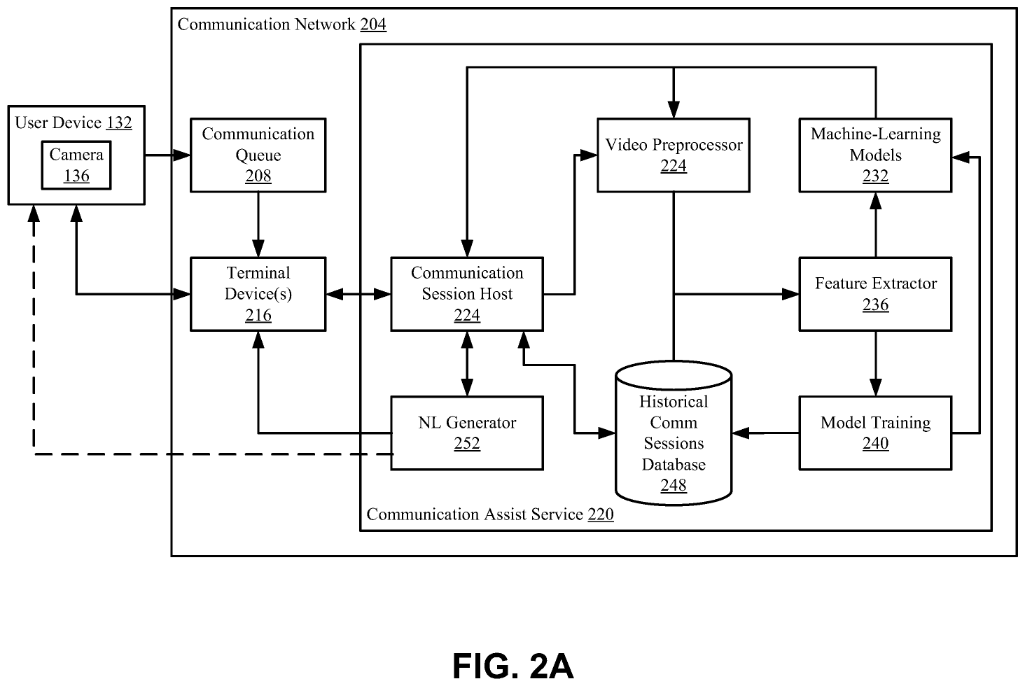

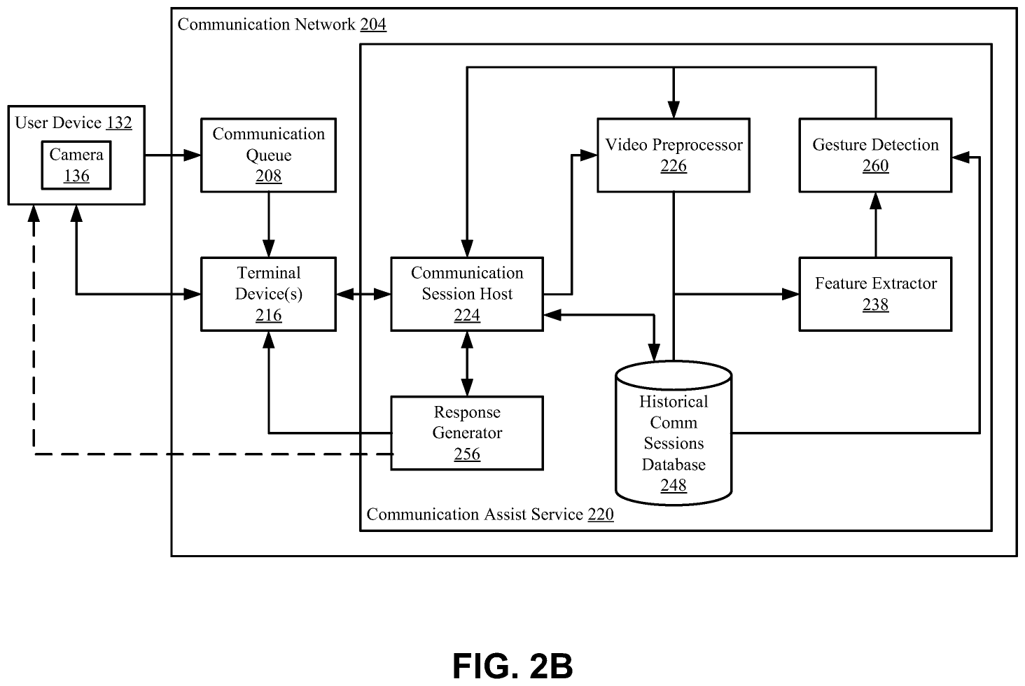

FIG. 2 illustrates a block diagram of an artificial-intelligence communication assistance system configure to train and use models to provide assistance to agents during video communications according to aspects of the present disclosure. Communication network 204 may be an example implementation of communication network 104 of FIG. 1 or may be another communication network. Communication network 204 may operate a communication queue 208 (e.g., a job queue), that stores an identification of user devices connected to communication network 204 that are awaiting a communication session with a terminal device and/or an automated service. Communication queue 208 may establish a communication session between user device 132 and terminal device 216. Communication queue 208 may also instantiate an AI communication assist service from communication assist service 220 by transmitting a request to communication session host 224. Communication assist service 220 may encapsulate the components of an automated service capable of processing video-based communication, voice-based communication (e.g., such as gestures, and/or the like), text-based communication, etc. and generating natural language responses that can be automatically provided (in an automated service implementation) or provided to an agent as suggested responses in real time.

Communication session host 224 may manage the backend portion of the communication session between user device 132 and terminal device 216 such as the AI communication assist service, establishing additional or alternative communication channels, analyzing communications transmitted during the communication session, etc. Upon receiving an identification of a new communication session from communication queue 208, communication session host 224 may transmit session information to video preprocessor 224. The information may include one or more video frames, an identification of a reason for user device 132 establishing the communication session (e.g., such as to execute a query for information associated with a user profile, account, etc.; discuss an issue with an automated service or agent, pay a balance, etc.), an identification of the user device and/or the user thereof, an identification of an object or service associated with the communication session, an identification of communication capabilities of the user, an identification of communication disabilities of the user, combinations thereof, or the like.

Video preprocessor 224 may process the received information associated with the communication session in real time and pass the preprocessed information to feature extractor 236 for use with machine-learning models 232. Machine-learning models 232 may include machine-learning models configured to provide various forms of assistance to agents and/or automated services. For example, machine-learning models 232 may include convolutional neural networks (e.g., configured to process video frames to detect gestures, identify gestures, translate gestures into a natural language communication, and/or the like), recurrent neural networks (e.g., configured to detect and identify motion gestures that may be represented over a sequence of video frames, retain features across multiple iterations, and/or the like); one or more cluster-based models (e.g., configured to process data derived from the communication session, data output from the concurrent neural network, data output from the recurrent neural network, etc. to classify gestures according to an intended, generate identifiers for training datasets, etc.). Machine-learning models 232 may be trained to generate an output associated with a particular gesture, etc. In some instances, video preprocessor 224 may also preprocess real time video of the communication session. The preprocessed video may be passed to feature extractor 236 for use with one or more machine-learning models of machine-learning models 232.

Machine-learning models 232 may include one or more machine-learning models such as, but are not limited to neural networks, generative adversarial networks, deep learning networks, recurrent neural networks, convolutional neural networks, classifiers, support vector machines, Naïve Bayes, K-nearest neighbors, K-means, random forest, other clustering-based models (e.g., neural network or other model using K-means, density-based spatial clustering of applications with noise, random forest, a gaussian mixture model, balance iterative reducing and clustering using hierarchies, affinity propagation, mean-shift, ordering points to identify the clustering structure, agglomerative hierarchy, spectral clustering, or the like), regression-based models, decision trees, and/or the like. In some instances, machine-learning models 232 may include one or more ensemble models (of one or more machine-learning models).

Feature extractor 236 may receive information from video preprocessor 2224 (e.g., such as information associated with the communication session, information derived from video frames extracted from the video session, etc.) and/or from historical comm sessions database 248 (e.g., such as information associated with historical communication sessions facilitated by communication network 204, etc.). Feature extractor 236 may define one or more feature vectors for machine-learning models 232 for training (e.g., model training 240) and for regular operations. Model training 240 may direct feature extractor 236 to define feature vectors from historical comm sessions database 248. The feature vectors may be aggregated into training datasets usable to train machine-learning models 232. In some instances, such as when the AI communication assist service generated an inaccurate output (e.g., did not identify a gesture, translated a gesture into an incorrect natural language communication, etc.), model training 236 may request the feature vectors that were passed as input into machine-learning models 232 resulting in the inaccurate output. The feature vector may be augmented with features extracted from historical comm sessions database 248, user feedback from user device 132, agent feedback from terminal device 216, and/or the like. The augmented feature vector may be used to further train machine-learning models 232 (e.g., for new models and/or fore reinforcement learning of existing models).

In some instances, model training 240 may facilitate the defining of training datasets that correspond to a same user to train machine-learning models 232 to generate outputs specific to that user. For example, since each user may have variations in communications capabilities and/or disabilities, each user may communicate using different gestures (and/or non-verbal sounds) or intend to convey different meaning to gestures (and/or non-verbal sounds). Model training 232 may use training data from historical communication sessions involving a particular user to a machine-learning model for that user. The training machine-learning model may be more accurate in detecting, identifying, and translating gestures of that user than a machine-learning model training from historical communication sessions involving other users. Model training 240 may train multiple versions of machine-learning models 232 such as one machine-learning model 232 for each user registered with communication network 204 with a communication impairment.

If historical comm sessions database 248 does not include enough data associated with a particular user to train machine-learning models 232, then model training 240 may identify data associated with one or more similar users (e.g., users having similar communication capabilities, users having similar communication disabilities, users that communicate using the same or similar gestures, combinations thereof, or the like). Model training 240 may then define a training dataset from data associated with the particular user and data associate with similar users. As more information is received from the particular user (e.g., such as after each communication sessions between the particular user and a terminal device of communication network 204), model training 240 may add it to the training dataset and remove a corresponding quantity of data associated with the similar users. The machine-learning models 232 for the particular user may then be retrained using new training dataset.

In some instances, a communication-impaired user may use a third-party (e.g., such as a social worker, aid, assistant, etc. to assist in communications. Communication network 204 may request information from the third-party that may be usable by model training 240 to train machine-learning models 232 for that communication-impaired user. For example, communication network 204 may request annotations and/or labels associated with video frames, an identification of gestures and/or non-verbal sounds, an identification of a meaning intended by a gesture and/or non-verbal sound, etc. The annotations and/or labels may be usable when training machine-learning models 232 (e.g., labels for supervised learning, etc.).

Machine-learning models 232 may be trained using supervised learning, unsupervised learning, semi-supervised learning, reinforcement learning, a combination thereof, or the like. The type of training may be selected based on a particular model to be trained, a target output or accuracy, whether a training feature vector includes labels (e.g., for supervised learning), etc. For example, a classifier such as a support vector machine can be trained using a combination of supervised learning and reinforcement learning. Model training 240 may train machine-learning models 232 for a predetermined time interval, over a predetermined quantity of iterations, until one or more accuracy metrics are reached (e.g., such as, but not limited to, accuracy, precision, area under the curve, logarithmic loss, F1 score, mean absolute error, mean square error, etc.), and/or the like. Once trained, model training 240 may continue to monitor accuracy metrics and/or other metrics of machine-learning models 232 (e.g., in real time or each time machine-learning models 232 generates a prediction or output, etc.). Machine-learning models 232 may be continually trained using reinforcement learning in regular intervals, upon detecting an event (e.g., such as when an accuracy metric falls below a threshold, a particular prediction or output, a confidence value, etc.), or the like. In some instances, model training 240 may determine to instantiate a new machine-learning model 232 based on the one or more accuracy metrics (e.g., such as when one or more accuracy metrics fall below a threshold, etc.).

Once machine-learning models 232 are trained, feature extractor 236 may generate feature vectors using video preprocessor 224 and characteristics of the communication session. The feature vector may be passed as input into machine-learning models 232 to generate one or more outputs that may assist terminal device 216 in resolving the issue associated with user device 132. The one or more outputs may be passed to video preprocessor 224 to further refine video preprocessing for subsequent video frames of the video session (e.g., by adjusting internal weights, modifying how video frames may be selected or prepared for feature extractor 236, selecting different processes, etc.). The one or more outputs may then be passed to communication session host 224. Communication session host 224 may evaluate the one or more outputs and determine which of the one or more outputs (e.g., none, one, some, or all) are to be passed on. For example, communication session host 224 may use confidence values associated with each output to determine whether to present the output to terminal device 216. Communication session host 224 may also determine whether to present the one or more outputs as a raw output (e.g., without any formatting or adjustments) or as natural language communications. For example, communication session host 224 may transmit the one or more outputs to natural language (NL) generator 252, which may generate natural language communications based on each of the one or more outputs. The natural language communications may be text-based, voice-based (e.g., via a synthetic voice, etc.), gesture-based (e.g., via a virtual rendering of human or a portion thereof, etc.), combinations thereof, or the like. The natural language communications may be presented terminal device 216. Terminal device 216 may determine if the communication should be presented to user devices 132 (e.g., via NL generator 252 or via the agent of agent device 216). The natural language communications may assist the agent to resolve the issue associated with user device 132.

Communication session host 224 may send the one or more outputs (and the inputs that generated the one or more outputs) to historical comm sessions database 248. In some instances, communication session host 224 may wait until the communication session terminates (satisfactorily or unsatisfactorily) and store outputs from machine-learning models 232 generated during the communication session, the inputs to the machine-learning models 232 that generated the outputs, information associated with communication session (e.g., identification the user device and/or the user thereof, an identification of the reported issues, an identification of the devices or services associated with the issues, an identification of the determined root cause or solutions, user feedback, agent feedback, etc.), combinations thereof, or the like in historical comm session database 248. Historical comm session database 248 may be used to generate training datasets for machine-learning models 232 as previously described.

FIG. 2B illustrates a block diagram of an example communication assistance system configured to provide assistance to agents during video communications according to aspects of the present disclosure. The communication assistance system of FIG. 2B may be an alternative version of the artificial-intelligence communication assistance system of FIG. 2A that provides similar or the same functionality using processes other than artificial intelligence and/or machine-learning. For example, video processor 226 of FIG. 2A may process video frames to generate one or more representations of the video frame or portions of the video frame. The one or more representations of the video frame or portions of the video frame can be passed to feature extractor 238 which may extract features from the one or more representations of the video frame or portions of the video frame. Gesture detection 260 may receive the one or more representations of the video frame or portions of the video frame and the extracted features. Gesture detection 260 may also receive representations of video frames (or portions thereof) associated with known gestures from historical comm session database 248. Gesture detection 260 may compare the one or more representations of the video frame or portions of the video frame with the representations of video frames (or portions thereof) associated with known gestures from historical comm session database 248 to identify a gesture represented in a video frame.

In some examples, video preprocessor 226 may extract one or more sets of pixels (referred to as pixel patches) derived from one or more video frames of the video session. A pixel patch may be of varying shapes (e.g., geometric shapes, non-geometric shapes, etc.). For example, each pixel patch may be a two-dimensional array of N×T where the value of N and T may be based on the particular features of the video frame from which the pixel patch was obtained, user input, learned features, and/or the like. Video preprocessor 226 may extract a set of pixel patches from each video frame. Each pixel patch of the set of pixel patches extracted from a same video frame may be of uniform size and shape or may be of varying sizes and shapes.

Video preprocessor 226 may extract pixel patches from particular locations of the one or more video frames. In some instances, the particular locations may be predetermined. For example, when camera 136 and the environment captured by camera 136 are static (e.g., camera 136 and the environment are not moving, rotating, etc. relative to each other), then gestures may be positioned within particular regions of each video frame. The particular regions may be selected based on previously processed video frames, user input, agent input, etc. In other instances, video preprocessor 226 may use a moving window to extract a set of pixel patches that include some or all of the pixels of a video frame. Video preprocessor 226 may extract pixel patches starting at a predetermined location (e.g., represented as a X,Y pixel coordinate) of the video frame incrementing the moving window in one or more directions from the predetermined location to extract subsequent pixel patches. For example, a first pixel patch of N×T size may be extracted at coordinates 0,0 (e.g., the top left corner of the video frame) a second pixel patch may be extracted at of (N+1),0. Video preprocessor 226 may also extract pixel patches in two or more directions. For instances, a third pixel patch may be extracted from of 0, (T+1) at the same time as the second pixel patch or after the second pixel patch.

In some instances, the moving window may move in increments that are smaller than N or T such that each pixel patch may include pixels of a previous pixel patch and/or a subsequent pixel patch (e.g., referred to as an overlapping moving window). Using overlapping moving window may ensure that at least one or more pixel patches extracted from a video frame include the majority of pixels representing a detectable gesture. For example, in some situations a normal moving window may cut off the pixels representing a gesture such that some of the gesture is represented in a first pixel patch and some of the pixels are represented in one or more other pixel patches. Gesture detection 260 may generate a false negative due when a pixel patch includes an insufficient quantity of pixels representing the gesture. The overlapping moving window may be incremented so as to increase a likelihood that an gesture of interest represented in a video frame will be detected using at least one pixel patch. For example, in some instances the overlapping moving window (of size N×T) may increment by 1 pixel such that video preprocessor 226 may extract a first pixel patch beginning at coordinates 0,0 and a second pixel patch beginning at coordinates 1,0. The first pixel patch may include pixels along the x-axis from 0 to N and the second pixel patch may include pixels along the x-axis from 1 to (N+1).

Video preprocessor 226 may then process each pixel patch before sending the processed pixel patches to feature extractor 238. Processing pixel patches can include color correction, conversion to grayscale, filtering, edge detection (e.g., such as a Fast Fourier Transform (FFT) highpass filtered or highpass replicate, etc.), padding, affine transformations, denoising, combinations thereof, or the like. In some instances, video preprocessor 226 may process each video frame before pixel patches are extracted from the video frames. In those instances, video preprocessor 226 may analyze the processed video frame and identify areas within the video frame that are likely representative of an gesture from which to extract pixel patches. By processing video frames before extracting pixel patches, video preprocessor 226 may reduce the quantity of pixel patches extracted from each video frame, which may reduce processing resource use and increase the speed in which gestures can be detected. For example, video preprocessor 226 may perform edge detection on a video frame including a representation of an apple in the center. The edge detection may reveal edges that corresponds to an outline of the apple. Video preprocessor 226 may isolate regions of the video frame including the edges from regions of the video frame that do not. For instance, video preprocessor 226 may identify the regions external from the edge of the apple such as pixels between the perimeter of the video frame and the edge of the apple. Video preprocessor 226 may then extract pixel patches from the remaining regions of the video frame (e.g., those regions including edges).

Feature extractor 238 may receive the (as processed and/or non-processed) pixel patches from video preprocessor 226 and reference pixel patches from historical comm sessions database 248. The reference pixel patches may include pixel patches from previous communication sessions for which a gesture was correctly or incorrectly identified as being represented by the pixel patch and other pixel patches. Alternatively, feature extractor 238 may receive reference video frames (e.g., processed in a similar or same manner as the video frames processed by video preprocessor 226) historical comm sessions database 248. The processed video frames may correspond to historical communication session for which a gesture was correctly or incorrectly identified as being represented by the processed video frames and/or other video frames. Each pixel patch and/or video frame from historical comm sessions database 248 may include a label that indicates the gesture represented by the pixel patch and/or video frame or an indication of gestures that are not depicted by the pixel patch and/or video frame.

Feature extractor 238 may extract features from each pixel patch and/or video frame. The features extracted from each pixel patch and/or video frame may depend on the type of gesture detection used by gesture detection 260. Gesture detection 260 identify for each pixel patch and/or video frame from video preprocessor 226 one or more matching reference pixel patch or reference video frame. Gesture detection 260 may perform the matching using the features extracted from feature extractor 238, the reference pixel patches and/or reference video frames, the processed pixel patches and/or video frames for video preprocessor 226, and/or the un-processed pixel patches and/or video frames for video preprocessor 226. Gesture detection 260 may use one or more matching algorithms to match a pixel patch or video frame to a reference pixel patch or reference video frame. Examples of matching algorithms include, but are not limited to, pattern analysis (e.g., such as, but not limited to linear or quadratic discriminant analysis, kernel estimation, clustering process such as k-means, principal component analysis, independent component analysis, etc.), shape analysis (e.g., comparing the orientation of subsets of pixels from a pixel patch or video frames to pixels of a reference pixel patch or video frame and identifying the reference pixel patch and/or video frame that is the closest match), keypoint matching, pixel color analysis (e.g., matching average red, green, blue values of pixels of a pixel patch with average red, green, blue values of reference pixel patches or video frames and identifying the reference pixel patch and/or video frame that is the closest match), perceptual hash (e.g., generating a hash from the features of pixel patch or video frame as a fingerprint to be matched to a hash generated from features of reference pixel patches and/or video frames), combinations thereof, or the like. Gesture detection 260 may assign a label to the pixel patch or video frame that corresponds to an identification of the detected gesture.

Some gestures may correspond to a static positioning of the user or agent (referred to as a static gesture). For example, in American Sign Language, letters of the English alphabet can be represented by a static positioning of one hand. Gesture detection 260 may identify static gestures from a single pixel patch or video frame. A confidence value (indicative of an accuracy of the label) may increase upon identifying a same static gesture in multiple contiguous pixel patches or video frames. Other gestures may correspond to a sequence of movements of the user or agent (e.g., referred to as dynamic gestures). Gesture detection 260 may detect and identify dynamic gestures by comparing a sequence of pixel patches or video frames to a corresponding sequence of historical pixel patches or video frames.

The identified pixel patches and/or video frames may include the label that identifies the gesture represented by the identified pixel patch and/or video frame. In some instances, the label may indicate a gesture that is not represented by the identified pixel patch and/or video frame. By identifying negative information, the object detection 226 may provide information to an agent or user that may assist the agent or user in identifying the gesture. The label of the identified pixel patches and/or video frames may be assigned to the pixel patch and/or video frame from video preprocessor 226 that is part of the current communication session. The label may be passed to communication session host 224, which may pass the label to response generator 256 to generate a communication based on the label.

In some instances, response generator 256 may generate a communication based on the labels of one or more pixel patches or video frames. A single gesture may represent a letter, word, phrase, sentiment, etc. Response generator 256 may combine the labels from a sequence of pixel patches or video frames based on the labels of each pixel patch or video frame to generate a complete a complete, word, phrase, sentence, and/or the like. Response generator 256 may compare the detected word, phrase, and/or sentences to historical words, phrases or sentences to normalize the detect word, phrase, and/or sentences. For example, response generator 256 may correct typos (e.g., from a misidentified gesture or from a incorrect gesture), add missing words or phrases, remove extra words or phrases, etc.

Response generator 260 may output the word, phrase, sentence, etc. as a communication to terminal device 216 and/or user device 216. The output from response generator 256 may include the communication and/or the video frames (or pixel patches) that include a representation of the gestures that contributed to the communication.

In some instances, gesture detection 260 may annotate the pixel patches and/or video frames to include additional information such as, but not limited to, a label indicating the gestures detected in the pixel patches and/or video frames, a boundary box surrounding detected gestures, metadata (e.g., such as an identification of terminal device 216 or the user thereof, an identification of user device 132 and/or the user thereof, characteristics of the communication session, features extracted by feature extractor 238, matching algorithm used to detect the gesture, confidence value corresponding to an accuracy of the matching algorithm, combinations thereof, or the like), combinations thereof, or the like. Communication session host 224 may determine whether to include the communication, the representative video frame, and/or the annotated video frame in an output.

In some instances, communication session host 224 may determine to output the communication, the representative video frame, and/or the annotated video frame each time a video frame detects a gesture. In other instances, to reduce processing resource consumption, communication session may limit the output. For example, communication session host 224 may output one communication, representative video frame, and/or annotated video frame when a gesture is detected. Communication session host 224 may not output another communication, a representative video frame, and/or an annotated video frame until a new gesture is detected (or no gesture is detected). In other words, communication session host 224 may only generate an output when the output is different from the previous output (e.g., a different gesture was detected, no gesture was detected, etc.). This may enable communication session host 224 to reduce the quantity of outputs without reducing the quantity or accuracy of the information being output to terminal devices and/or user devices. Alternatively, or additionally, terminal device 216 and/or user device 132 may specify the content of particular outputs and/or the frequency in which outputs may be generated.

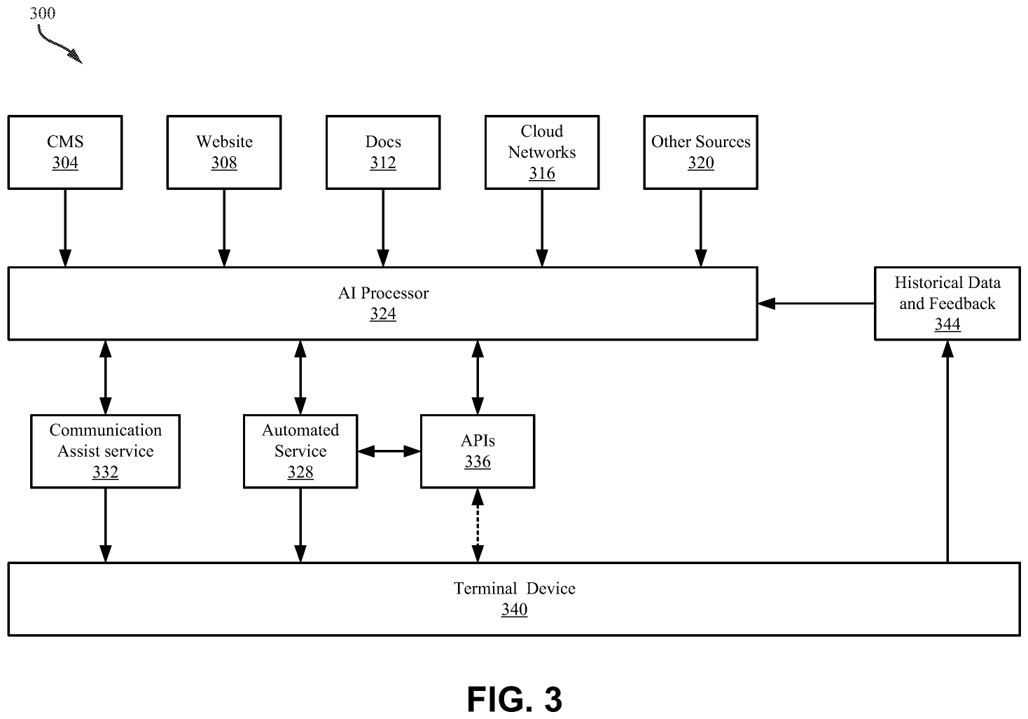

FIG. 3 depicts a block diagram of an example artificial-intelligence data processing system of an automated service configured to automate communications of a communication network according to aspects of the present disclosure. Artificial-intelligence data processing system 300 may be configured to facilitate and maintain communications between an agent of a communication network and an automated service, between an agent of a communication network and a user, between a user and an automated service, and/or the like. User devices (e.g., operated by users) may connect to the communication network using a variety of different device types and capabilities to request assistance to perform an action (e.g., execute a query for information, pay a balance, communicate with a customer service agent, receive technical support, etc.). The communication network may automate some or all of the communications transmitted to user devices. The communication network may facilitate and maintain communication using artificial-intelligence data processing system 300, which can, for example, connect the user device to automated service 328 or to a terminal device operated by an agent assisted by communication assist service 332.

Artificial-intelligence data processing system 300 may be a component of one or more computing devices (e.g., terminal devices, mobile devices, telephones, desktop or laptop computers, servers, databases, etc.) that operate within the communication network. In some instances, an instance of artificial-intelligence data processing system 300 may be a component of one or more computing devices of communication network or of one or more computing devices operating separately from the communication (e.g., such as via external terminal devices configured to provide services one or more communication networks, etc.). The one or more computing devices may connect to the communication network to enable the communication network to route communications between a user device and the instance of artificial-intelligence data processing system 300 operating separately from the communication network. In some instances, multiple artificial-intelligence data processing systems may be instantiated, each including different capabilities and being configured to communicate with different device types and/or users. For instances, each artificial-intelligence data processing system 300 may be trained to communicate with users having different communication impairments. The communication network may route communications received from a user device to a particular instance of artificial-intelligence data processing system 300 based on a degree in which the instance of artificial-intelligence data processing systems 300 matches the user device and/or an availability of the instances of artificial-intelligence data processing system 300.

Artificial-intelligence data processing system 300 may receive data from a variety of disparate information sources for use training and executing automated services and agents to communicate and provide information to users. Examples of information sources include, but are not limited to, content management systems 304, websites 308, documents 312 (e.g., via a document management system, concurrent versioning system, file system, database, etc.), cloud networks 316, communication networks (e.g., one or more devices configured to facilitate communications over one or more communication channels between users and other users and/or between users and agents), terminal devices (e.g., devices configured to communicate with user devices, etc.), other sources 320 (e.g., analytics services, Internet-of-Things (loT) devices, databases, servers, any other information source or storage device, etc.), sensor-based devices (e.g., device including sensors and/or devices connected to sensors, etc.), and/or the like.

The manner in which artificial-intelligence data processing system 300 receives data from data sources 304-120 may be based on the data source. For example, some data sources such as IoT devices may transmit a data stream to which artificial-intelligence data processing system 300 may be connected. For some data sources, artificial-intelligence data processing system 300 may transmit a request for particular data and/or for datasets stored by a data source. Artificial-intelligence data processing system 300 may transmit requests in regular intervals (e.g., such as a batch request to one or more data sources, etc.), upon detecting or being notified of new data, and/or the like. For some data sources, artificial-intelligence data processing system 300 may use one or more APIs exposed by a data source to access data generated or stored by data source. For some data sources, artificial-intelligence data processing system 300 may instantiate a process configured to scrape data from a data source (e.g., such as web crawler, etc.). The process may execute to access and transmit data of a data source to artificial-intelligence data processing system 300. Some data sources may transmit data to artificial-intelligence data processing system 300 each time new data is generated and/or stored by the data source. Some data sources may transmit data continuously as a data stream that devices such as the artificial-intelligence data processing system can connect. Alternatively, or additionally, some data sources may broadcast the data stream to devices configured to or adapted to receive the data stream (e.g., such as the artificial-intelligence data processing system, etc.).

Data of a data source can include any type of information. Some data may correspond to information associated with an object, entity, or topic, that may be requested by a user. Some data sources may store records, documents, files, or the like. For example, a data source may store a record of a conversation (e.g., in an audio format, alphanumeric format, or the like) between a user and an agent. Another data sources may store sensor data from one or more connected sensors (e.g., such as motion sensors, temperature sensors, etc.).

Data from data sources may be received by AI processor 324. AI processor 324 may be configured to process the data into a format usable by one or more conversation services (e.g., automated services 328, conversation assist 332, APIs 336, and/or the like) and/or information-distribution services. AI processor 324 may include one or more devices, processes, machine-learning models, and/or the like configured to process received data. AI processor 324 may store the sematic information of any received data regardless of the data type of the received data.

AI processor 324 may preprocess the data to convert the received data into one or more general formats. AI processor 324 may identify a data type associated with the received data (e.g., based on identifying audio data, video data, alphanumeric strings, a particular file type extension, etc.) and allocate a process and/or machine-learning model capable of processing the identified data type. For example, if the received data includes audio segments from voice communications, AI processor 324 may allocate a machine-learning model configured to process audio segments into alphanumeric strings (e.g., a speech-to-text translation, audio classification, etc.). For video segments AI processor 324 may allocate machine-learning models configured to classify images, perform object detection, etc. AI processor 324 may then store the preprocessed data.

In some instances, AI processor 324 may augment the preprocessed data by adding additional features corresponding to contextual information, metadata, etc. For example, AI processor 324 may identify contextually relevant information based on, but not limited to, information associated with the origin device from which the data was transmitted and/or a user thereof (e.g., such as, but not limited to, demographic information, location information, an identification of hardware and/or software included within the origin device, an Internet Protocol (IP) address, a media access control address (MAC), etc.), information associated with the communication that included the information (e.g., such as an IP address, a MAC address, an identification of an origin location of the communication, an identification one or more servers through which the communication traveled, a data size, a quantity of packets, a packet size, etc.), information associated with preceding or subsequently received data, information associated with linked data (e.g., data referenced by the data to be stored, or data that references the data to be stored, etc.), and/or the like. AI processor 324 may extract features from the augmented data to add to the preprocessed data. Alternatively, or additionally, AI processor 324 may determine which features to add to the preprocessed data based on a classification of the data to be stored (e.g., such as audio or text-based conversation data, video data, information data, etc.).

AI processor 324 may receive requests for information from automated service 328, conversation assist 332, and APIs 336. Automated service 328 may include one or more processes, machine-learning models, and/or devices configured to communicate with user devices, terminal devices, other device, and/or other automated services. An example implementation of an automated service may be communication assist service 220 of FIG. 2. Automated service 328 may communicate with terminal device 340 over a communication channel through a communication network. During a communication session, automated service 328 may receive a communication from terminal device 340 and generate and transmit a response to the terminal device 340 using a same or communication type as the received communication. In some instances, automated services 328 may be configured to communicate in a manner such that a user or agent operating terminal device 340 may not detect that automated service 328 is not a human. For example, automated service 328 may be configured to generate responses that are based on a same orthography and/or communication convention (e.g., language, diction, grammar, slang, abbreviations, gestures, non-verbal sounds, etc.) as used by the user or agent. Alternatively, automated service 328 may be configured to generate responses that are based on an orthography and/or communication convention commonly used for the communication channel of the communication session and demographic information associated with the user or agent (e.g., location of the user or agent, age, etc.). Automated service 328 may be configured to communicate over an audio interface (e.g., a telephone call, etc.), a video interface (e.g., video conference, etc.), one or more textual interfaces (e.g., text messaging, instant messaging, email, direct messaging, and/or the like), or the like.

In some instances, automated service 328 may request information from AI processor 324 during a communication session with a user and/or other automated service. For example, during the communication session, a user may ask a question. Automated service 328 may parse the question to determine a question type, identify information that will resolve the question, an interface type of the interface through which automated service 328 is communicating with the user or other automated service, and/or one or more contextually relevant features that may increase an accuracy of the response that will be generated by automated service 328. Automated service 328 may then execute a query to automated processor 328 for the information.

AI processor 324 may receive the query and identify data associated with one or more potential responses to the query. In some instances, AI processor 324 may generate a confidence value for each of the one or more potential responses that includes the requested information. The confidence value may be generated based on a degree in which a potential response matches the query (e.g., based on a quantity of features of the potential response that correspond to the query, or the like). AI processor 324 may then rank the one or more potential responses and identify a particular potential response having a highest confidence value. Alternatively. AI processor 324 may identify a set of potential responses of the one or more potential responses having a confidence value greater than a threshold.

AI processor 324 may then translate the response into a representation that can be transmitted via the communication channel connecting user device 320 to automated service 328. For example, if the user is communicating with automated service 328 via a telephonic interface (e.g., voice-based communications, etc.), then AI processor 324 may translate the particular response into one or more alphanumeric strings that include a conversational representation of the information with a diction, grammar, etc. that may be parsable by the user based on communication capabilities of the user. AI processor 324 may then transmit a representation of the particular response to terminal device 340 as a suggested response that can be conveyed to the user by the agent, translate the one or more alphanumeric strings into a synthetic voice representation that may be presented by automated service 328, translate the one or more alphanumeric strings into a representation of one or more gestures that maybe understandable by the user (e.g., which may be conveyed automatically via an animated, virtual representation of the agent, or by the agent, etc.), combinations thereof, or the like. Alternatively. AI processor 324 may pass the one or more alphanumeric strings to automated service 328 and automated service may generate the synthetic voice representation or gesture representation of the one or more alphanumeric strings (e.g., using a speech-to-text process, machine-learning model, etc.).

Automated services 328 may include one or more machine-learning models configured to process input from terminal device 340. The one or more machine-learning models may be selected based on a communication channel over which the communications may be received. For instances, text communications may be processed by a classifier, audio communications may be processed by a recurrent neural network, video communications may be processed by a convolutional neural network (e.g., configured to process video channel such as the video frames) and/or one or more recurrent neural networks (e.g., configured to process the audio channel and to retain information for subsequent iterations of the convolutional neural network or recurrent neural network, etc.), etc. Automated services 328 may utilize other machine-learning models to perform other operation associated with the communication session such as, but not limited to, classifiers, pattern analysis, root-cause analysis, solution analysis, etc. AI processor 324 may select the one or more machine-learning models that may be configured to assist terminal device 340 based on the communication channel and characteristics of the communication session (e.g., device or service associated with the communication session, reported issue, etc.).

In some instances, automated services 328 may include a sequence of machine-learning models that operate together to process incoming communications, generate responses, and transmit the responses to the user or agent over the same communication channel over which the incoming communications were received. The machine-learning models may be trained using training datasets derived from data that correspond to historical communications transmitted over similar communication channels. Each training dataset may include a sequence (e.g., ordered) or set (e.g., unordered) of data usable to train a particular machine-learning model (e.g., recurrent neural network, Naïve Bayes, etc.) to generate a target output (e.g., predictions, classifications, image processing, audio processing, video processing, natural language processing, generative, etc.).

In some instances, additional features may be added to the training datasets to augment the semantic meaning of the data of the training datasets and/or to provide context usable by the automated service to generate subsequent communications. The additional data may correspond to features extracted from other portions of the training dataset, features associated with a source of the training datasets (e.g., features that correspond to a data source or device, features that identify the data source, etc.), features associated with a user that generated or is associated with the data of the training datasets, an identification of a data type of the data of the training datasets, a timestamp corresponding to when the data of the training datasets was generated and/or received, combinations thereof, or the like.

AI processor 324 may select one or more training datasets for each machine-learning model based on the target output for that machine-learning model. The communication network may the modify the training datasets to optimally train a particular machine-learning to generate a particular target output.

The AI processor 324 may then train the machine-learning models to generate a target output. The one or more machine-learning models may be trained over a training time interval that may be based on a predetermined time interval or based on a target accuracy of the machine-learning model. For example, the training time interval may begin when training begins and end when a target accuracy metric is reached (e.g., accuracy, precision, area under the curve, logarithmic loss, F1 score, mean absolute error, mean square error, etc.). The machine-learning models may be trained using supervised learning, unsupervised learning, semi-supervised learning, reinforcement learning, combinations thereof, or the like. The type of training to be used may be selected based on the type of machine-learning model being trained. For instance, a regression model may use supervised learning (or a variation thereof), while a clustering model may be trained using unsupervised learning (or a variation thereof), etc. Alternatively, the type of learning may be selected based on the target output and/or a type or quality of the training data available to train the machine-learning models.

Once the one or more machine-learning models are trained, AI processor 324 may define processes and/or interfaces configured to connect the one or more machine-learning models to enable a single input to generate an output expected by terminal device 340. For example, a first communication may be received from a communication-impaired user (e.g., such as a gesture, non-verbal sound, sequence of gestures, sequence of non-verbal sounds, etc.). The processes and/or interfaces enable the one or more machine-learning models to operate together to, for example: detect the gesture(s) and/or non-verbal sound(s), classify the gesture(s) and/or non-verbal sound(s) as corresponding to one or more communications, translate the one or more communications into a natural language communication based on the one or more communications and one or more previous communications transmitted proximate to the first communication, execute a query to generate a response to the first communication (if additional information or external information is needed or requested), transmit the natural language communication to a terminal device for agent review along with the response to the query, generate a natural language communication response that can be automatically transmitted to the user device or transmitted to the terminal device as suggested response, convert the natural language response to speech using a text-to-speech machine-learning model (if the communication capabilities of the user include hearing or language processing), convert the natural language response to a virtual representation of a gesture (e.g., conveyed using an animated avatar of the automated service or agent, etc.) using a generative adversarial network or other machine-learning model, etc. Alternatively, one or more of the aforementioned machine-learning models or algorithms may be combined into a single machine-learning model. The processes and/or interfaces may enable the output of one machine-learning model to be used as input into another machine-learning model by processing the output into a different form or format (e.g., if needed) and into a format expected by a next machine-learning model in the sequence. The AI processor 324 may define multiple processes and/or interfaces to organize the one more machine-learning models into difference sequences configured to process different forms of communication (e.g., speech, gesture-based communications, data, text, etc.) received over different communication channels (e.g., videoconference, telephone, text, data, etc.). As a result, each of the processes and/or interfaces may structure the one or more machine-learning models in various configurations and sequences based on the communication channel and communications transmitted over the communication channel.

Communication assist service 332 may include one or more processes and/or devices configured to assist an agent during a communication session between a user and an agent or automated service 328 and an agent. An example implementation of an automated service may be communication assist service 220 of FIG. 2. For example, communication assist service 332 may be an automated service with a modified output layer that presents one or more outputs of an automated service to the human agent (rather than automatically transmitting the output to the agent or user). The agent may then select an output from the one or more outputs and present it to the user. As a result, during a communication session, conversation assist 332 may operate in a same or similar manner as automated service 328.

For example, communication assist service 332 may analyze audio segments, video frames, etc. received during a communicating session between a user device operated by a communication-impaired user and terminal device 340. Communication assist service 332 may then detect a gesture and/or non-verbal sound from the user, determine a meaning of the gesture and/or non-verbal sound, generate one or more proposed responses based on the meaning, etc. If additional information is needed communication assist service 332 may transmit queries to AI processor 324 for the additional information (in a same or similar manner as previously described). AI processor 324 may generate the response including the requested information and translate the information into a format native to the communication channel of the communication session.

Communication assist service 332 may present the one or more suggested responses and/or other information generated by communication assist service 332. The information may include a simplified grammatical structure, such as a shorthand that can be translated by the agent, one or more representations of gestures that may convey the meaning of the suggested response to the user, etc. Alternatively, the information may be presented in a formal grammatical format (e.g., including a particular sentence structure, wording/phrasing, grammar, punctuation, etc. that is native to the communication network being used). The agent may determine how to use the information generated by communication assist service 332. For example, the agent may determine that the communication assist service 332 correctly determined the root cause of the issue and provide that information to the user device.

Communication assist service 332 may also provide suggested communications that can be provided to the user device. The agent may select from among one or more suggested responses to present a suggested response to the user or automated service 328. Alternatively, the agent may present a response defined by the agent. The response may be presented to the user as if the response was generated by the agent (e.g., the agent may speak the response or the response may be written out and appear as if generated by the agent, etc.).

In instances in which multiple responses are generated, conversation assist 332 may rank or score each response so as to provide the agent with options that may be selectively presented over the communication session. The rank or scores may be based on one or more algorithms configured to maximize a probability that particular event will occur (e.g., such as resolving a user issue or complaint, providing a response to a query, causing the user to sign up for a service, causing the user to generate a new profile, cause the user to purchase an item, etc.). A score may include a probability value corresponding to the probability that a particular event may occur if a particular response is selected, an indication in which the probability value will change if a particular response is selected, etc.

APIs 336 may include a set of interfaces exposed to terminal device 340, automated services 328, and/or other devices authorized to access AI processor 324. The set of interfaces may allow terminal device 340 to execute functions of AI processor 324, such as, but not limited to establishing communications between terminal device 340 and other devices or services, establish connection contexts, modify connection contexts, execute queries for information, etc. The APIs may be wrapped within an application configured to execute functions of the APIs. Alternatively, the application may connect to APIs 336 or execute remote calls to the functions of APIs 336. The application may include graphical user interfaces and/or command line interfaces that enable terminal device 340 to selectively execute the functions of APIs 336. APIs 336 may include one or more APIs accessible via different interface types usably by terminal device 340.

In some instances, APIs may be accessible to devices operating within a same communication network as AI processor 324 (e.g., terminal devices, etc.). Devices outside the communication network may lack the capability and/or authorization to access APIs. External devices may connect to automated service 328 and request the execution of functions of AI processor 324. Automated service 328 may receive the request, determine if the request should be authorized (e.g., based on the requesting device and/or a user thereof, etc.), and define one or more function calls from APMs 336 that will implement the requested functionality.

Terminal device 340 may generate one or more metrics corresponding to the communication session between terminal device 340 and/or an agent thereof and a user device and/or a user thereof, terminal device 340 and automated service 328, automated service 328 and another automated service 328, terminal device 340 operating conversation assist 332 and a user device or automated service 328, terminal device 340 and AI processor 324 via APIs 336, a user device and automated service 328, and/or any other communications of a service involving AI processor 324. The one or more metrics may be manually generated (e.g., by a user, agent, or the like) and/or automatically generated (e.g., by a communication application, automated service 328, conversation assist 332, AI processor 324, etc.) based on the occurrence of events during the communication session, an analysis of communications transmitted and/or received, a satisfaction of the user or agent, etc. For example, the one or more metrics may include an indication of an accuracy of a response to a communication transmitted by a user or agent (e.g., indicating a degree with which AI processor 324 identified the correct information), a degree in which communications conformed to the communication channel used for the communication session (e.g., indicating whether communications used an appropriate conversational standard associated with the communication channel), and/or the like. The one or more metrics may be transmitted to historical data and feedback 344.

Historical data and feedback 344 may store records of communication sessions (e.g., the one or more metrics, communications transmitted to and/or received by terminal device 340, feedback from the user, feedback from the agent, feedback from the automated service 336, and/or the like) between terminal device 340 and user devices. Historical data and feedback 344 may use the records of one or more communication sessions to define one or more feature vectors usable to train the machine-learning models of AI processor 324. The feature vectors may be used for reinforcement learning and/or to train new machine-learning models based on the historical communications and the one or more metrics and/or feedback generated from those communications. In some instances, labels may be derived from the one or more metrics and/or feedback generated from the communications for supervised learning, semi-supervised learning, reinforcement learning, etc.). Machine-learning models may be trained for predetermined time interval, for a predetermined quantity of iterations, until a predetermined accuracy metric (e.g., accuracy, precision, area under the curve, logarithmic loss. F1 score, mean absolute error, mean square error, etc.) is reached, and/or the like. The one or more metrics and/or feedback may be used to determine an on-going quality of the output of a machine-learning model. If the one or more metrics and/or feedback indicate that the quality of a machine-learning model is below a threshold, then historical data and feedback 344 may retrain the machine-learning model, instantiate and train a new machine-learning model, and/or the like.

In some instances, the feature vectors may be used for reinforcement learning and/or other types of on-going learning. In those instances, a trained machine-learning model used during a communication session to generate a response (e.g., by translating a potential response into a conversational response native to a particular communication channel), may execute a reinforcement-learning iteration using the feature vector used to generate the response, the one or more metrics, and one or more thresholds to qualify the one or more metrics. The reinforcement-learning iteration may adjust internal weights of the machine-learning model to bias the machine-learning model towards or away from generating particular responses. If the one or more metrics associated with a response are high relative to the one or more thresholds (e.g., indicating the response is correlated with a good or accurate result), then reinforcement learning may bias the machine-learning model to generate responses similar to that response. If the one or more metrics associated with a response are low relative to the one or more thresholds (e.g., indicating the response is correlated with a poor or inaccurate result), then reinforcement learning may bias the machine-learning model to generate responses different from that response.

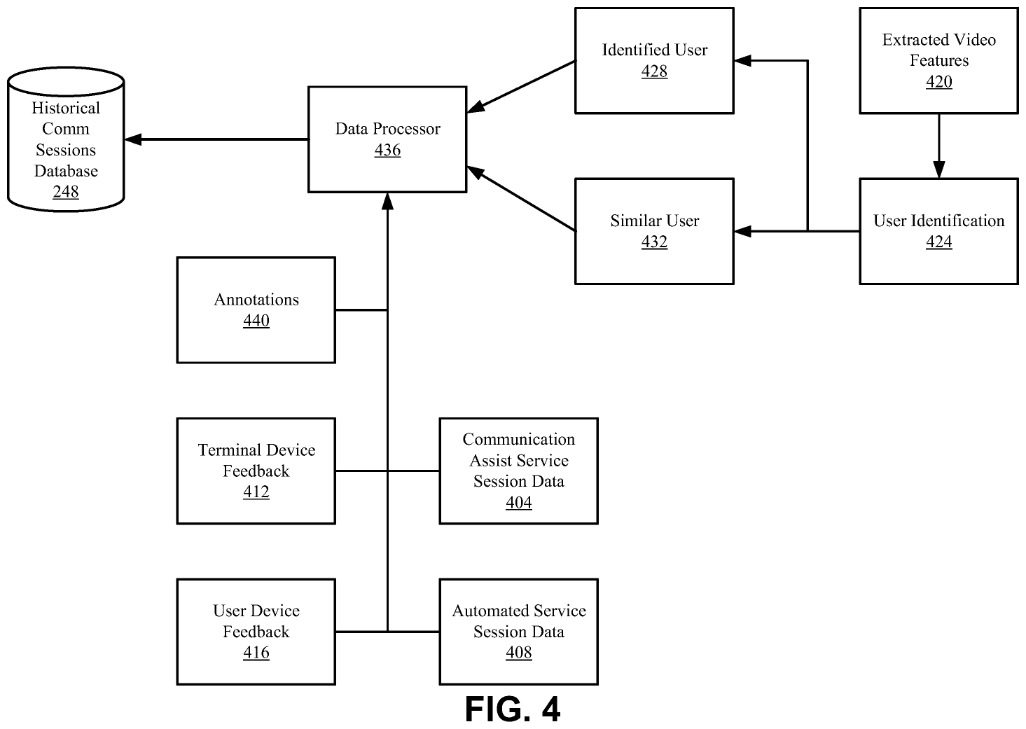

FIG. 4 illustrates a block diagram of an example system for aggregating training data configured to train machine-learning models to provide assistance in video communications for particular communication-impaired users according to aspects of the present disclosure. Historical comm sessions database 248 may store data associated with a communications session between a terminal device and a user device in discrete datasets. Historical comm sessions database 248 may assign identifiers to each dataset to enable aggregating particular datasets into training datasets. For example, communication assist services may train neural networks to detect objects, gestures of the user and/or agent, issues, non-verbal sounds of the user and/or agent, etc. associated with particular communication-disabled users to reduce the quantity of datasets needed to train the neural networks. Training neural networks for use with particular users may also increase the accuracy of the output generated by neural networks when operating with input from the corresponding user. The communication assist service may train and store multiple of each type of machine-learning model to enable assisting a terminal device with each communication-disabled user for which the communication network provides services. The communication assist service may train machine-learning models according any of the identifiers assigned to datasets.

Examples of identifiers include, but are not limited to, an identification of the user device and/or the user thereof, an identification of the terminal device and/or the agent thereof, an identification of the product and/or service for which the communication session was established, an identification of the issue for which the communication session was established, an identification of the communication capabilities of the user, an identification of the communication capabilities of the agent, a resolution of the communication session (e.g., an indication as to whether the issue was resolved and how, etc.) provided by the automated service and/or agent, demographic information associated with the user and/or agent, an identification of previous communication sessions between the user and the communication network or agent, an identification of previous communication sessions between the agent and other users, characteristics of the communication session (e.g., length of the communication session, communication channels utilized during the communication session, etc.), and/or the like.

The communication assist service may determine which of the one or more identifiers to select to define a training dataset that may result in the most accurate machine-learning model with the broadest possible use. For instance, selecting multiple identifiers may enable generating a machine-learning model that is highly accurate in generating an output from particular communication sessions (e.g., that have similar or the same matching identifiers). The narrow scope of datasets may also result in a hyper-focused machine-learning model that may not be able to generate accurate outputs during communication sessions that do not match the identifiers, which may reduce the quantity of communication sessions where the machine-learning model may be usable. The communication assist service may use historical comm sessions database 248 to select a minimum of one or more identifiers that may enable training machine-learning models to a target accuracy metric. Alternatively, the communication assist service may use historical comm sessions database 248 to select identifiers that may enable training machine-learning models that will have a widest usability metric (e.g., based on a quantity of communication sessions in which the machine-learning model may be usable). Alternatively, still, the communication assist service may use historical comm sessions database 248 to select identifiers to train a machine-learning model to a target accuracy metric given a constraint such as a minimum usability metric. For example, the communication assist service may select identifiers based on the resulting training dataset being able to train a machine-learning model that meets a minimum usability metric to a target accuracy metric.

In some instances, historical comm sessions database 248 may first use an identification of a user for which the machine-learning models may be used. If no there is insufficient quantity of data with an identifier corresponding to the identified user, then historical comm sessions database 248 may select one or more other identifiers to define the training datasets. For example, since each communication-impaired user may communicate using different gestures, assign different meaning to gestures, use different or no non-verbal sounds, etc., each user may have a unique communication form. The communication network may attempt to define machine-learning models to assist particular users based on the unique communication form of that user. If historical comm sessions database 248 lacks enough information to generate a training dataset for the particular user (e.g., there are minimal historical communication sessions between the particular user and the communication network, historical comm sessions database 248 may augment the data with data associated with one or more other users with similar communication capabilities (e.g., based on assigned identifiers). Alternatively, the communication network may use already trained machine-learning models that are predicted to match the communication capability of the particular user (e.g., based on a confidence value, etc.).

Historical comm sessions database 248 may receive data for a dataset from communication assist service session data 404 (e.g., if a communication assist service operated during the communication session), automated service session data 408 (e.g., if an automated service operated during the communication session), terminal device feedback 412 (e.g., information associated with the communication session provided by the terminal device and/or the agent thereof), user device feedback 416 (e.g., information associated with the communication session provided by the user device and/or the user thereof), extracted video features 420, or the like. Extracted video features 420 may include features extracted fmm the video session including from video frames, audio segments, text, data, metadata, etc. Extracted video features 420 may include representative video frames and/or processed video frames (e.g., as processed by the machine-learning models described herein, annotated by users and/or agents, etc.) usable to training the machine-learning models described herein. For example, extracted video features 420 may include an identification of boundary boxes positioned over identified gestures or objects of interest; labels associated with identified gestures and/or video frames; characteristics of video frames, etc.

During a video session between a communication-impaired user and an agent, the communication network may use extracted video features 420 for user identification 424. User identification 424 may identify the communication-impaired user (e.g., by name, user identifier, handle, or the like) or classifying the communication capabilities of the communication-impaired user. For example, user identification 424 may use a machine-learning model that may classify the communication capabilities of the communication-impaired user as corresponding to one or more categories. The one or more categories may be based on types of gestures represented in the extracted video features (e.g., indicative of a common set of gestures used by one or more users), a meaning of one or more gestures represented in the extracted video features (indicative of a common set of meanings assigned to gestures by one or more users), an identification of sounds conveyed by one or more users (e.g., indicative of a common set of sounds used by one or more users), an identification of meanings assigned to sounds conveyed by one or more users (indicative of a common set of meanings assigned to sounds by one or more users), a rating indicative of the communication capabilities of the user, an identification of communication disabilities (e.g., hearing, speech, sight, etc.), combinations thereof, or the like.

User identification 424 may output an identification dataset indicative of an identify of the user corresponding to the video session from which extracted video features 420 were derived and/or the communication capabilities of the user. The communication network may determine if a particular user can be identified (e.g., identified user 428) or if the particular user cannot be identified (e.g., similar user 432). Similar user 432 may identify a set of users that may have similar communication capabilities as the user of the video session. In some instances, the set of users may be identified as particular users (e.g., by a user identifier, username, handle, etc.). In other instances, the set of users may be anonymous and identified based on having common communication capabilities and/or communication disabilities. Data processor 436 may receive the data from identified user 428 and/or similar user 432 as well as data associated with the user from communication assist service session data 404 (if connected to the video session), automated service session data 408 (if connected to the video session), terminal device feedback 412, user device feedback 416, annotations 440 (e.g., translations, notes, annotations, labels, etc. provided by a third-party assigned to assist the particular user such as an aid or social worker). Data processor 336 may define a dataset associated with the particular user (e.g., usable to train a communication assist service, automated service, machine-learning models, etc.). Alternatively, or additionally, data processor 336 may define a dataset for users having similar communication capabilities and/or disabilities as the particular user (e.g., usable to train a communication assist service, automated service, machine-learning models, etc.).

The datasets may be stored in historical comm session database 248. For example, the communication network may use the dataset to train a communication assist service based on the particular communication capabilities and communication disabilities of a particular communication-impaired user. If the particular user is unknown to the communication network, the dataset may be used to train or identify a communication assist service configured to assist in communicating with similar users

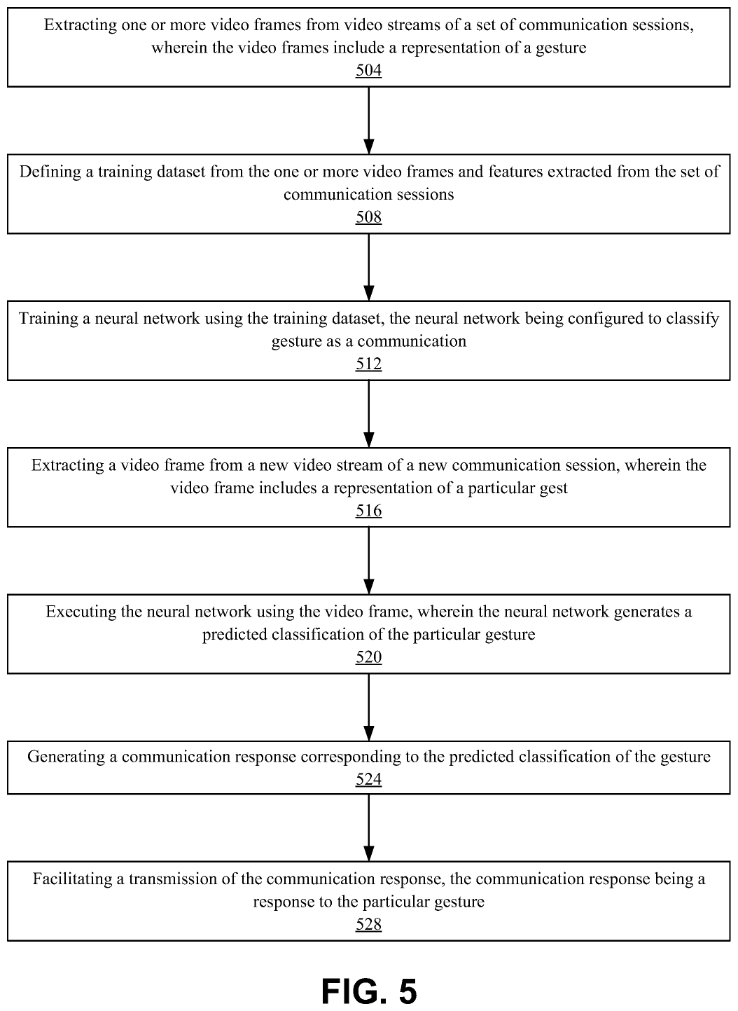

FIG. 5 illustrates a flowchart of an example process for artificial-intelligence assistance in video communications according to aspects of the present disclosure. At block 504, a computing device may extract one or more video frames from video streams of a set of historical communication sessions. The video frames may include a representation of a gesture made by a user communicating over the communication session with an agent operating a terminal device. For example, the user may have a communication-based disability that prevents or limits the user's ability to communicate using verbal-based communications (e.g., such as a hearing-impairment, speech-impairment, muscle-impairment, etc.).

In some instances, the computing device may also extract features from the video data associated with each category. The features may correspond to information associated with the video data or a particular video session represented in the video data. For example, the features may include characteristics of a video session; an identification of the users, agents, automated services, user devices, terminal devices, etc. involved in the video session; an identification of an outcome of the video session; an identification of the time in which the video session began; the duration of the video session; an identification of a location of the user device or the user thereof; a label to be associated with the video session during a training phase; combinations thereof; or the like.

At block 508, the computing device may define a training dataset from the one or more video frames and features extracted from the set of communication sessions. The training dataset may include data from a set of communication sessions including, but not limited to, one or more video frames from each video session, features derived from the one or more video frames and/or the communication session, and/or the like. The training dataset may be derived from communication sessions involving a single user. Since each user may communicate using different gestures from other users, defining a training dataset derived from communication sessions involving a same user may result in a training dataset capable of training a neural network to generate the most accurate gesture translations for that user. The computing device may assign identifiers to the training dataset (and/or to the data derived from a communication session). An identifier corresponds to a characteristic of a communication session that enables. The computing device may use the identifiers to identify a training dataset (and/or data associated with a communication session) that may be similar to or the same as a reference communication session associated with a particular user.

The one or more identifiers may be generated by a machine-learning model (e.g., such as a clustering-based model) configured to detect patterns and/or common features from the historical communication sessions. Examples of identifiers that may be included in the one or more identifiers may include, but are not limited to, an identification of the user (e.g., a user identifier, a user profile, etc.), an identification of the user device operated by the user (e.g., such as a telephone number, Internet Protocol (IP) address, media access control address, mobile advertising ID (MAID), hardware and/or software installed within the user device, communication software and/or protocols used or usable by the user device, etc.), communication capabilities and/or disabilities of the user, communication capabilities of the terminal device and/or the agent thereof, one or more issues for which the communication session was established, an indication of the resolution of the communication session (e.g., where the issues of the user addressed, etc.), a time interval of the communication session, an indication as to whether the terminal device and/or the agent were able to communicate with the user, an identification of third-parties (if any) associated with the communication sessions (e.g., social workers and/or other individuals that improved communications transmitted from the user device), an identification of one or more gestures provided by the user and/or the agent, an indication of whether non-verbal sounds improved or worsened communications between the user and the agent, an identification of the non-verbal sounds provided by the user with a corresponding assigned meaning (if available), and/or the like.

The computing device may assign one or more weights to each identifier according to a multi-purpose hierarchical framework. The multi-purpose hierarchical framework may generate weights for identifiers based on a particular use of the identifier. For instance, a first weight may be generated for identifiers when identifying data of a communication session that may be used for a particular user. In that instance, identifiers associated with an identity of the particular user may be weighted higher than other identifiers (e.g., so as to enable defining datasets from communication sessions to which the particular user was a party). The multi-purpose hierarchical framework may assign other weights to the same identifiers when identifying data of a communication session that may be associated with a particular gesture or sound. The weights may be generated by the machine-learning model, the neural network, user and/or agent input, preset inputs, combinations thereof, and/or the like.

The identifiers and the weights assigned to identifiers may be used to tailor training of a neural network to a particular user and/or group of users. In some instances, the neural network may be trained using datasets associated with a particular user to enable generating a trained neural network configured to translate gestures and/or sounds more accurately for the particular user. In those instances, the weighted identifiers may first identify training datasets (and/or data associated with communication session) that correspond to the particular user. In other instances, the quantity of quality of training datasets associated with the particular user may be insufficient to train the neural network to a threshold accuracy. In those instances, the weighted identifiers may be used to identify additional training datasets that may be a closest fit (e.g., based on which weighted identifiers match the identifiers of the particular user, a quantity of matching identifiers, and/or the like) to the particular user. The computing device may use the training datasets associated with the similar users to train the neural network. Alternatively, the computing device may add some or all of the training datasets associated with the similar users to the training datasets associated with the particular user.

At block 512, the computing device may train a neural network using the training dataset. The neural network may be configured to classify gestures of a user as communications. For example, the neural network may be configured to output a predicted classification that corresponds to an identification of the gesture, a natural language translation of the gesture, one or more potential responses to the gesture, combinations thereof, or the like. The neural network may be any of the previously described machine-learning models. In some instances, the neural network may be an ensemble neural network that includes two or more machine-learning models. The two or more machine-learning models may be arranged in parallel (e.g., each generating an output), in series (e.g., the output from one machine-learning model may passed as input into the next machine-learning model, combinations thereof (e.g., with some machine-learning models operating in series, while other machine-learning models operating in parallel), or the like.

The neural network may be using supervised learning, unsupervised learning, semi-supervised learning, reinforcement learning, and/or the like. The neural network may be trained for a predetermined time interval, for a predetermined quantity of iterations, until one or more accuracy thresholds are satisfied (e.g., such as, but not limited to, accuracy, precision, area under the curve, logarithmic loss, F1 score, mean absolute error, mean square error, combinations thereof, or the like), based on user input, combinations thereof, or the like. Once trained, the neural network may be useable to process video frames of new video sessions in real time (e.g., identifying objects, generating boundary boxes, translating gestures into natural language communications, generating communication responses, etc.).

At block 516, the computing device may extract a video frame from a new video stream of a new communication session. The new communication session may be a video-based communication session including a user device operated by a user who may be speech-impaired and an agent device. The video frame may include a representation of a particular gesture intended to convey meaning by the user.

The computing device may determine a frequency with which to extract video frames from the video stream. For example, the computing device may extract each video frame from the video stream (e.g., for 30 frames per second, etc.) when processing resources of the computing devices are available. If the processing load of the computing device increases beyond a threshold, the computing device may switch to a lower extraction rate such as every other video frame (e.g., for 15 frames per second, etc.), every nth video frame, etc. The more video frames extracted per unit time, increases the quantity and accuracy of predictions generated by the neural network. The more video frames extracted per unit time may also reduce the time interval between when data of the neural network is provided to the agent.

At block 520, the computing device may execute the neural network using the video frame. The neural network may generate a predicted classification of the particular gesture. The neural network may classify gestures according to one or more classifications with each classification corresponding to a meaning. The neural network may predict the classification of the gesture and then assign the meaning corresponding to the predicted classification to the gesture. In some instances, the neural network may generate the predicted output based on the particular gesture and one or more previous communications transmitted over the new communication session (e.g., from the user device and/or from the agent device). For example, during a conversation a current statement may be based on one or more previous statements made during the conversation or on one more classified gestures (e.g., where each gesture may represent a portion of a word, phrase, sentence, etc.). The neural network may process the current video frame based on the previous communications transmitted over the new communication channel to define a context that may improve the accuracy of the neural network. In some instances, a representation of each identified gesture may be transmitted to the terminal device. The representation may include text (e.g., the letter, word, phrase, sentence, sentiment, etc.), an audio segment (e.g., from a text-to-speech model in a synthetic voice), a representative video frame in which the identified gesture is included, an annotated version of the video frame (e.g., which may include a boundary box surrounding the identified gesture, label, metadata, etc.), combinations thereof, or the like.

At block 524, the computing device may generate a communication response based on the response to the predicted classification of the gesture. In some instances, the communication response may be generated by the neural network. In other instances, the communication response may be generated by another machine-learning model such as, but not limited to, a generative adversarial network, deep learning network, a recurrent or convolutional neural network, etc. The communication response may be a natural language communication based on the predicted classification of the gesture. For example, the predicted classification of the gesture may correspond to a request for information associated with a previous communication (e.g., in which the gesture was a shrug, hand gesture with the palm(s) facing upwards, movement of the head, wrinkling of the skin above eyes, or the like). The communication response may include a natural language communication that includes a request for the additional information associated with the previous communication. Alternatively, the communication may be a sequence of one or more gestures that approximately corresponds to a meaning (to the user) of the natural language response. The sequence of one or more gestures may include the same or similar gestures as used by the user so as to use gestures having a meaning that is known to the user.

At block 528, the computing device may facilitate a transmission of the communication response to a device associated with the new communication session. The communication response be transmitted as text, audio segments (e.g., provided by a text-to-speech model as a synthetic voice, etc.), images, video, a combination thereof, or the like. In some instances, the computing device may be configured to operate in an automated setting in which the computing device may automatically generate and transmit the communication response to the user device in response to detecting the gesture. In other instances, the computing device may be configured to operate in an assist setting in which the computing device may automatically generate one or more communication responses in response to detecting the gesture. The one or more communication responses may be transmitted to the terminal device for presentation to the agent thereof. The agent may determine which of the one or more communication responses to transmit to the user device. The agent may communicate the selected one or more communication responses to the user via natural language communications (e.g., voice-based and/or text based). Alternatively, the agent may communicate the selected one or more communication responses to the user via a sequence of one or more gestures that approximately correspond to the meaning (to the user) of the selected one or more natural language communications.

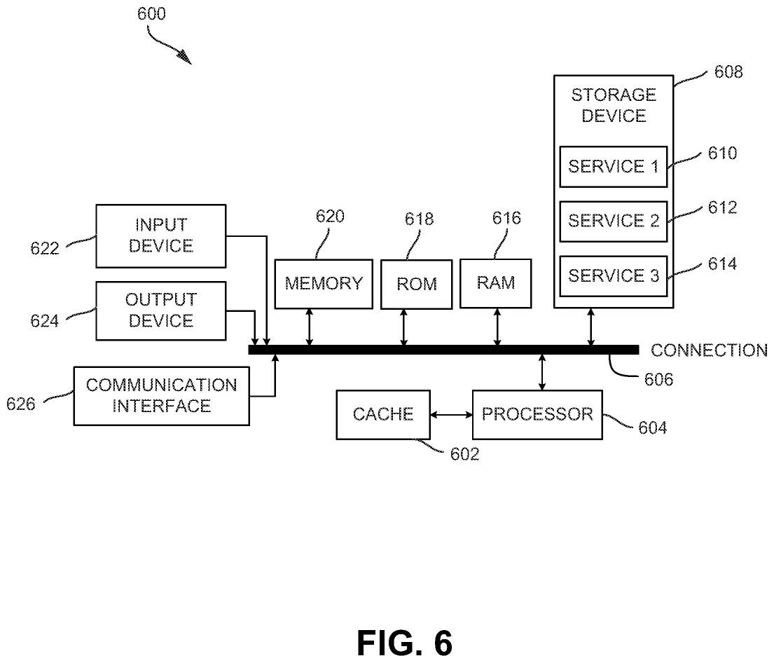

FIG. 6 illustrates an example computing system architecture including various components in electrical communication with each other and configured to implement aspects of the present disclosure. FIG. 6 illustrates a computing system architecture 600 including various components in electrical communication with each other using a connection 606, such as a bus, in accordance with some implementations. Example system architecture 600 includes a processing unit (CPU or processor) 604 and a system connection 606 that couples various system components including the system memory 620, such as ROM 618 and RAM 616, to the processor 604. The system architecture 600 can include a cache 602 of high-speed memory connected directly with, in close proximity to, or integrated as part of the processor 604. The system architecture 600 can copy data from the memory 620 and/or the storage device 608 to the cache 602 for quick access by the processor 604. In this way, the cache can provide a performance boost that avoids processor 604 delays while waiting for data. These and other modules can control or be configured to control the processor 604 to perform various actions.

Other system memory 620 may be available for use as well. The memory 620 can include multiple different types of memory with different performance characteristics. The processor 604 can include any general-purpose processor and a hardware or software service, such as service 1 610, service 2 612, and service 3 614 stored in storage device 608, configured to control the processor 604 as well as a special-purpose processor where software instructions are incorporated into the actual processor design. The processor 604 may be a completely self-contained computing system, containing multiple cores or processors, a bus, memory controller, cache, etc. A multi-core processor may be symmetric or asymmetric.

To enable user interaction with the computing system architecture 600, an input device 622 can represent any number of input mechanisms, such as a microphone for speech, a touch-sensitive screen for gesture or graphical input, keyboard, mouse, motion input, speech and so forth. An output device 624 can also be one or more of a number of output mechanisms known to those of skill in the art. In some instances, multimodal systems can enable a user to provide multiple types of input to communicate with the computing system architecture 600. The communications interface 626 can generally govern and manage the user input and system output. There is no restriction on operating on any particular hardware arrangement and therefore the basic features here may easily be substituted for improved hardware or firmware arrangements as they are developed.

Storage device 608 is a non-volatile memory and can be a hard disk or other types of computer readable media which can store data that are accessible by a computer, such as magnetic cassettes, flash memory cards, solid state memory devices, digital versatile disks, cartridges, RAMs 616, ROM 618, and hybrids thereof.

The storage device 608 can include services 610, 612, 614 for controlling the processor 604. Other hardware or software modules are contemplated. The storage device 608 can be connected to the system connection 606. In one aspect, a hardware module that performs a particular function can include the software component stored in a computer-readable medium in connection with the necessary hardware components, such as the processor 604, connection 606, output device 624, and so forth, to carry out the function.

The disclosed waterfall gateway system can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example, and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor. The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, WA, and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the terms “computer readable medium”, “computer readable storage medium”, “machine-readable medium” and “machine-readable storage medium” should be taken to include a single medium or multiple media (e.g., a centralized or distributed database, and/or associated caches and servers) that store the one or more sets of instructions. The terms “computer readable medium”, “computer readable storage medium”, “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for” Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included (e.g., in FIG. 5). A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a keypad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
extracting one or more video frames from video streams of a set of communication sessions, wherein the video frames include a representation of a gesture;
defining a training dataset from the one or more video frames and features extracted from the set of communication sessions;
training a neural network using the training dataset, the neural network being configured to classify gesture as a communication;
extracting a video frame from a new video stream of a new communication session, wherein the video frame includes a representation of a particular gesture;
executing the neural network using the video frame, wherein the neural network generates a predicted classification of the particular gesture;
generating a communication response corresponding to the predicted classification of the gesture; and
facilitating a transmission of the communication response, the communication response being a response to the particular gesture.

2. The computer-implemented method of claim 1, wherein the new communication session is between a user device and a terminal device.

3. The computer-implemented method of claim 1, wherein the particular gesture is a static position of a body part.

4. The computer-implemented method of claim 1, wherein the particular gesture is a motion involving one or more body parts.

5. The computer-implemented method of claim 1, further comprising:
extracting an audio segment from the new communication session that corresponds to the video frame, wherein executing the neural network further uses the audio segment.

6. The computer-implemented method of claim 1, wherein the neural network is an ensemble network comprising two or more neural networks configured to generate outputs of different types.

7. The computer-implemented method of claim 1, wherein the neural network is configured to generate a boundary box over the particular gesture.

8. A system comprising:
one or more processors; and
a non-transitory machine-readable storage medium storing instructions that when executed by the one or more processors, cause the one or more processors to perform operations including:
extracting one or more video frames from video streams of a set of communication sessions, wherein the video frames include a representation of a gesture;
defining a training dataset from the one or more video frames and features extracted from the set of communication sessions;
training a neural network using the training dataset, the neural network being configured to classify gesture as a communication;
extracting a video frame from a new video stream of a new communication session, wherein the video frame includes a representation of a particular gesture;
executing the neural network using the video frame, wherein the neural network generates a predicted classification of the particular gesture;
generating a communication response corresponding to the predicted classification of the gesture; and
facilitating a transmission of the communication response, the communication response being a response to the particular gesture.

9. The system of claim 8, wherein the new communication session is between a user device and a terminal device.

10. The system of claim 8, wherein the particular gesture is a static position of a body part.

11. The system of claim 8, wherein the particular gesture is a motion involving one or more body parts.

12. The system of claim 8, wherein the operations further comprise:
extracting an audio segment from the new communication session that corresponds to the video frame, wherein executing the neural network further uses the audio segment.

13. The system of claim 8, wherein the neural network is an ensemble network comprising two or more neural networks configured to generate outputs of different types.

14. The system of claim 8, wherein the neural network is configured to generate a boundary box over the particular gesture.

15. A non-transitory machine-readable storage medium storing instructions that when executed by one or more processors, cause the one or more processors operations including:
extracting one or more video frames from video streams of a set of communication sessions, wherein the video frames include a representation of a gesture;
defining a training dataset from the one or more video frames and features extracted from the set of communication sessions;
training a neural network using the training dataset, the neural network being configured to classify gesture as a communication;
extracting a video frame from a new video stream of a new communication session, wherein the video frame includes a representation of a particular gesture;
executing the neural network using the video frame, wherein the neural network generates a predicted classification of the particular gesture;
generating a communication response corresponding to the predicted classification of the gesture; and
facilitating a transmission of the communication response, the communication response being a response to the particular gesture.

16. The non-transitory machine-readable storage medium of claim 15, wherein the new communication session is between a user device and a terminal device.

17. The non-transitory machine-readable storage medium of claim 15, wherein the particular gesture is a static position of a body part.

18. The non-transitory machine-readable storage medium of claim 15, wherein the particular gesture is a motion involving one or more body parts.

19. The non-transitory machine-readable storage medium of claim 15, further comprising:
extracting an audio segment from the new communication session that corresponds to the video frame, wherein executing the neural network further uses the audio segment.

20. The non-transitory machine-readable storage medium of claim 15, wherein the neural network is configured to generate a boundary box over the particular gesture.
